(19) United States
(12) Patent Application Publication
(10) Pub. No.: US 2021/0296630 A1
(43) Pub. Date: Sep. 23, 2021

(54) SECONDARY BATTERY USING BIPOLAR ELECTRODE

(71) Applicant: HONDA MOTOR CO., LTD., Tokyo (JP)

(72) Inventors: Shigemitsu AKUTSU, Saitama (JP); Shinji FUJIMOTO, Saitama (JP); Toru SUKIGARA, Saitama (JP); Shintaro AOYAGI, Saitama (JP)

(21) Appl. No.: 17/202,319

(22) Filed: Mar. 15, 2021

(30) Foreign Application Priority Data
Mar. 19, 2020 (JP) 2020-049249

(51) Int. Cl. H01M 4/13; H01M 50/54; H01M 50/172; H01M 50/124; H01M 10/0585

(52) U.S. Cl. CPC H01M 4/13; H01M 50/54; H01M 2004/029; H01M 50/124; H01M 10/0585; H01M 50/172

(57) ABSTRACT

Provided are a partial power generation element configured by a single laminate body in which a bipolar electrode is laminated, or a multi-layer laminate body in which a plurality of the single laminate bodies is laminated; and a positive electrode normal electrode and negative electrode normal electrode, in which the partial power generation element configures a serial partial power generation element in which the single laminate body which is a constituent element of the multi-layer laminate body is laminated between the positive electrode normal electrode and negative electrode normal electrode with an orientation of polarity configuring a serial connection, and between the positive electrode collector electrode and two negative electrode normal electrodes corresponding thereto, the serial partial power generation element joins with reverse polarity sandwiching the positive electrode collector electrode to configure a parallel connection body by connecting in parallel the serial partial power generation elements between the positive electrode collector electrode and two negative electrode normal electrodes.

This application is based on and claims the benefit of priority from Japanese Patent Application No. 2020-049249, filed on 19 Mar. 2020, the content of which is incorporated herein by reference.

### BACKGROUND OF THE INVENTION

### Field of the Invention

The present invention relates to a secondary battery made using a bipolar electrode.

### Related Art

It has been proposed to form a small module by retaining a single cell in a frame assuming a plate shape, forming a laminate unit by laminating a plurality of these small modules in the thickness direction of the frame, and integrally retaining the laminate unit by pressing with heat shrink from both sides in the lamination direction, thereby configuring a vehicle battery unit (for example, refer to Patent Document 1).

Patent Document 1: Japanese Patent No. 4501905

Patent Document 2: Japanese Patent No. 4300310

Patent Document 3: U.S. Pat. No. 9,972,860

### SUMMARY OF THE INVENTION

In a secondary battery made using a bipolar electrode, it assumes a configuration laminating a plurality of single laminate bodies in which a bipolar electrode is laminated on the side of at least one surface of a solid electrolyte layer for obtaining the required voltage between output terminals, so as to make a serial connection body connecting the single laminate bodies in series, and further connecting the serial connection bodies in parallel. However, there remains a problem regarding parallel connection in the point of the size reduction and productivity of the secondary battery due to requiring many conductors for connection.

The present invention has been made taking account of the above-mentioned situation, and has an object of providing a secondary battery made using a bipolar electrode superior in productivity which is small size, even in a case of connecting in parallel a plurality of serial connection bodies made by connecting single laminate bodies in series.

According to a first aspect of the present invention, a secondary battery comprises a bipolar electrode including: a partial power generation element which is configured by a single laminate body, in which bipolar electrode (for example, the bipolar electrode 17 described later) having a positive electrode (for example, the positive electrode mixture slurry 19 described later) of a polarizable electrode formed on one surface and a negative electrode (for example, the negative electrode mixture slurry 20 described later) of the polarizable electrode formed on the other surface of one sheet-like collector (for example, the sheet-like collector 18 described later), is laminated on at least one surface side of a solid electrolyte layer (for example, the solid electrolyte layer 2 described later), or is configured by a multi-layer laminate body in which a plurality of the single laminate bodies is laminated; and a normal electrode (for example, the positive electrode normal electrode 3, negative electrode normal electrode 4 described later) of a form laminated directly or indirectly via the solid electrolyte layer on the one surface side and the other surface side of the partial power generation element, and in which poles of the same polarity are formed on both surfaces of one sheet-like collector, wherein the partial power generation elements configure a serial partial power generation element in which the single laminate bodies which are constituent elements of the multi-layer laminate body are laminated between the normal electrode on the one surface side and the other surface side with an orientation of polarity configuring a serial connection, and configure, with one of the normal electrodes as a shared electrode (for example, the positive electrode collector electrode 3a, negative electrode collector electrode 4a described later), a parallel connection body in which the serial partial power generation elements are joined with reversed polarity sandwiching the shared electrode, between the shared electrode and two of the normal electrodes corresponding thereto, and the serial partial power generation elements are connected in parallel between the shared electrode and two of the normal electrodes.

According to a second aspect of the present invention, in the secondary battery comprising the bipolar electrode as described in the first aspect, the normal electrode is either a positive electrode normal electrode (for example, the positive electrode normal electrode 3 described later) of a form laminated on one surface side of the partial power generation element and having a pole of positive polarity formed on both surfaces of one sheet-like collector, or a negative electrode normal electrode (for example, the negative electrode normal electrode 4 described later) laminated on the other surface side of the partial power generation element and having a pole of negative polarity formed on both surfaces of the one sheet-like collector.

According to a third aspect of the present invention, in the secondary battery comprising the bipolar electrode as described in the second aspect, the secondary battery configures a parallel connection body of a first form (for example, the parallel connection body of a first form 27a, 27b, 27c described later) in which the serial partial power generation element is joined, with one of the positive electrode normal electrodes as a positive electrode collector electrode (for example, the positive electrode collector electrode 3a described later), between the positive electrode collector electrode and two of the negative electrode normal electrodes corresponding thereto, to sandwich the positive electrode collector electrode with reversed polarity, and the serial partial power generation element is connected in parallel between the positive electrode collector electrode and two of the negative electrode normal electrodes.

According to a fourth aspect of the present invention, in the secondary battery comprising the bipolar electrode as described in the second aspect, the secondary battery configures a parallel connection body of a second form (for example, the parallel connection body of a second form 28 described later) in which the serial partial power generation element is joined, with one of the negative electrode normal electrodes as a negative electrode collector electrode (for example, the negative electrode collector electrode 4a described later), between the negative electrode collector electrode and two of the positive electrode normal electrodes corresponding thereto, to sandwich the negative electrode collector electrode with reversed polarity, and the serial partial power generation element is connected in parallel between the negative electrode collector electrode and two of the positive electrode normal electrodes.

According to a fifth aspect of the present invention, in the secondary battery comprising the bipolar electrode as described in the second aspect, a parallel connection body of a first form (for example, the parallel connection body of a first form 27a, 27b, 27c described later) in which the serial partial power generation element is joined, with one of the positive electrode normal electrodes as a positive electrode collector electrode (for example, the positive electrode collector electrode 3a described later), between the positive electrode collector electrode and two of the negative electrode normal electrodes corresponding thereto, to sandwich the positive electrode collector electrode with reversed polarity, and the serial partial power generation element is connected in parallel between the positive electrode collector electrode and two of the negative electrode normal electrode, and a parallel connection body of a second form (for example, the parallel connection body of a second form 28 described later) in which the serial partial power generation element is joined, with one of the negative electrode normal electrodes as a negative electrode collector electrode (for example, the negative electrode collector electrode 4a described later), between the negative electrode collector electrode and two of the positive electrode normal electrodes corresponding thereto, to sandwich the negative electrode collector electrode with reversed polarity, and the serial partial power generation element is connected in parallel between the negative electrode collector electrode and two of the positive electrode normal electrodes, together configure a composite parallel connection body (for example, the composite parallel connection body 29a, 29b, . . . 29t described later) by sharing the serial partial power generation element between the positive electrode collector electrode or the negative electrode collector electrode, and one of the negative electrode normal electrode or the positive electrode normal electrode.

According to a sixth aspect of the present invention, in the secondary battery comprising the bipolar electrode as described in the fifth aspect, the composite parallel connection body provides a connection conductor corresponding to each of the positive collector electrode and the negative collector electrode (for example, the positive electrode sub-connection conductor 101, 102, 120a, 120b, 120c, 120d; negative electrode sub-connection conductor 111, 112, 130a, 130b, 130c, 130d described later), and provides a positive electrode collector electrode plate (for example, the positive electrode collector electrode plate 30 described later) and a negative electrode collector electrode plate (for example, the negative electrode collector electrode plate 31 described later) for supplying output power to outside collectively to each of the connection conductors of positive polarity and negative polarity.

According to a seventh aspect of the present invention, in the secondary battery comprising the bipolar electrode as described in the sixth aspect, the positive electrode collector electrode plate and the negative electrode collector electrode plate, as well as the partial power generation element have a projected shape to a plane perpendicular to the lamination direction of the partial power generation element which is an approximate rectangular shape, and the positive electrode collector electrode plate and the negative electrode collector electrode plate have conductor connection parts (for example, the electrode 30a, 30b, 30c, 30d; 31a, 31b, 31c, 31d described later), which connect to the connection conductors of positive polarity and negative polarity which are corresponding, formed at a plurality of locations to be separated in a vicinity of diagonals of the approximate rectangular shape.

According to an eighth aspect of the present invention, in the secondary battery comprising the bipolar electrode as described in the fifth aspect, the negative electrode normal electrode is located at both outermost end portions in the lamination direction of the composite parallel connection body.

According to a ninth aspect of the present invention, in the secondary battery comprising the bipolar electrode as described in the fifth aspect, the positive electrode normal electrode is located at both outermost end sites in the lamination direction of the composite parallel connection body.

According to a tenth aspect of the present invention, in the secondary battery comprising the bipolar electrode as described in the sixth or seventh aspect, a positive electrode tab (for example, the positive electrode tab 10 described later) and a negative electrode tab (for example, the negative electrode tab 11 described later) for supplying output electric power to outside are respectively provided in the positive electrode collector electrode plate and the negative electrode collector electrode plate.

According to an eleventh aspect of the present invention, the secondary battery comprising the bipolar electrode as described in the tenth aspect, further includes an outer packaging (for example, the outer packaging 12 described later) of laminate material enveloping the composite parallel connection body and the connection conductors of positive polarity and negative polarity, wherein a part of the positive electrode tab and the negative electrode tab are respectively led to outside from the outer packaging.

According to a twelfth aspect of the present invention, in the secondary battery comprising the bipolar electrode as described in the eleventh aspect, the secondary battery connects in parallel an odd number of a serial-multi-layer laminate body in which a plurality of single laminate bodies are laminated in a form of serial connection; disposes in parallel the positive electrode collector electrode plate and the negative electrode collector electrode plate at a central part between both ends in the lamination direction of the single laminate bodies; arranges between the positive electrode collector electrode plate and the negative electrode collector electrode plate an intermediate insulation sheet (for example, the intermediate insulation sheet 15) insulating between both of the collector electrode plates; and does not provide an insulation sheet between both outermost ends in the lamination direction of the single laminate bodies and an inner surface of the outer packaging.

According to a thirteenth aspect of the present invention, in the secondary battery comprising the bipolar electrode as described in the eleventh aspect, the secondary battery connects in parallel an odd number of a serial-multi-layer laminate body in which a plurality of single laminate bodies are laminated in a form of serial connection; arranges in parallel the positive electrode collector electrode plate and the negative electrode collector electrode plate at one end side among both ends in the lamination direction of the single laminate bodies, so that the negative electrode collector electrode plate is closed to an outer side than the one end; arranges between the positive electrode collector electrode plate and the negative electrode collector electrode plate an intermediate insulation sheet insulating between both of the collector electrode plates; and does not provide an insulation sheet between the other end side among both ends in the lamination direction of the single laminate bodies and the inner surface of the outer packaging, and between the negative electrode collector electrode plate and the inner surface of the outer packaging.

The secondary battery made using the bipolar electrode of the first aspect configures a parallel connection body in which, with one normal electrode as a shared electrode, a serial partial power generation elements are joined with reversed polarity sandwiching the shared electrode, between this shared electrode and two normal electrodes corresponding thereto, whereby the serial partial power generation elements are connected in parallel between the shared electrode and the two normal electrodes. For this reason, a connection conductor for configuring a parallel connection body is not needed at a portion of the shared electrode, and thus the number of connection conductors as a whole is reduced.

With the secondary battery made using the bipolar electrode of the second aspect, relative to one normal electrode serving as a shared electrode, a bipolar battery (battery made using a bipolar electrode) of serial connection serving as the target of parallel connection is configured between the shared electrode and the positive electrode collector electrode, and between the shared electrode and the negative electrode collector electrode, and thus simplification in configuration is realized.

With the secondary battery made using the bipolar electrode of the third aspect, with the positive electrode normal electrode as the positive electrode collector electrode, a serial partial power generation element is configured between the positive electrode collector electrode and two negative electrode normal electrodes corresponding thereto, and the parallel connection body of the first form is configured in which this serial partial power generation element is joined with reverse polarity sandwiching the positive electrode collector electrode, connected in parallel between the positive electrode collector electrode and two negative electrode normal electrodes. For this reason, the parallel connection body of the first form in which serial connection bodies of the bipolar battery are connected in parallel is simply configured, and it is possible to utilized even as an element of a more complex configuration.

With the secondary battery made using the bipolar electrode of the fourth aspect, with the negative electrode normal electrode as the negative electrode collector electrode, a serial partial power generation element is configured between the negative electrode collector electrode and two positive electrode normal electrode corresponding thereto, and a parallel connection body of the second form is configured in which this serial partial power generation elements are joined with reverse polarity sandwiching the negative electrode collector electrode, and are connected in parallel between the negative electrode collector electrode and two positive electrode normal electrodes. For this reason, the parallel connection body of the second form in which serial connection bodies of the bipolar battery are connected in parallel is simply configured, and it is possible to utilized even as an element of a more complex configuration.

With the secondary battery made using the bipolar electrode of the fifth aspect, the parallel connection body of the first form of the third aspect and the parallel connection body of the second form of the fourth aspect configure a composite parallel connection body by sharing the serial partial power generation elements between the positive electrode collector electrode or negative electrode collector electrode and one of the negative electrode normal electrode or positive electrode normal electrode. For this reason, a battery of composite parallel type which obtains the required output voltage by a series number (serial pole number) of the serial connection body of single laminate bodies, and obtains the required capacity by the parallel group number of this serial pole number is easily configured.

With the secondary battery made using the bipolar electrode of the sixth aspect, connection conductors are respectively provided to correspond to the positive electrode collector electrode and negative electrode collector electrode, and the positive electrode collector electrode plate and negative electrode collector electrode plate for supplying output power to outside are provided collectively to each of these connection conductors of positive polarity and negative polarity. For this reason, connection of conductors for guiding output to outside from the composite parallel connection body of the fifth aspect is simplified.

With the secondary battery made using the bipolar electrode of the seventh aspect, the positive electrode collector electrode plate and the negative electrode collector electrode plate, as well as the partial power generation element have a projected shape to a plane perpendicular to the lamination direction of the partial power generation element which is an approximate rectangular shape, and the positive electrode collector electrode plate and the negative electrode collector electrode plate have conductor connection parts, which connect to the connection conductors of positive polarity and negative polarity which are corresponding, formed at a plurality of locations to be separated in a vicinity of diagonals of the approximate rectangular shape. For this reason, the electrical current flow paths related to the arrangement of conductors in the case of guiding the output to outside from the composite parallel connection body of the sixth aspect are differentiated for both positive and negative electrodes, and differentiation of the internal resistance value can be measured.

With the secondary battery made using the bipolar electrode of the eighth aspect, the positive electrode normal electrode is located at both outermost end sites in the lamination direction of the composite parallel connection body of the fifth aspect. For this reason, the potentials of the electrodes at both outermost end parts contacting with the outer packaging are equal, and safety is ensured even without providing an insulating body or the like for reinforcing between the outer packaging.

With the secondary battery made using the bipolar electrode of the ninth aspect, the negative electrode normal electrode is located at both outermost end sites in the lamination direction of the composite parallel connection body of the fifth aspect. For this reason, the potentials of the electrodes at both outermost end sides contacting with the outer packaging are equal, and safety is ensured even without providing an insulating body or the like for reinforcing between the outer packaging.

With the secondary battery made using the bipolar electrode of the tenth aspect, particularly in the case of the sixth or seventh aspect, the positive electrode tab and negative electrode tab for supplying outer power to outside are provided to the positive electrode collector electrode plate and negative electrode collector electrode plate. For this reason, the configuration of the conductor part for drawing out the output power is simplified.

With the secondary battery made using the bipolar electrode of the eleventh aspect, particularly in the case of the tenth aspect, an outer packaging of laminate material enveloping the composite parallel connection body and the connection conductors of positive polarity and negative polarity is provided, and a part of the positive electrode tab and the negative electrode tab are respectively led to outside from the outer packaging. For this reason, the handling is easy.

With the secondary battery made using the bipolar electrode of the twelfth aspect, by connecting in parallel an odd number of serial multi-layer laminate bodies in which a plurality of the single laminate bodies are laminated in the form of serial connection, and arranging in parallel the positive electrode collector electrode plate and negative electrode collector electrode plate at a central part between both ends in the lamination direction of the single laminate body, both outermost ends in the lamination direction of the single laminate body become the same potential. For this reason, it is possible to assume a configuration not providing an insulation sheet between both outermost ends in the lamination direction of the single laminate body and the inner surface of the outer packaging, and thus the number of insulation sheets can be reduced.

With the secondary battery made using the bipolar electrode of the thirteenth aspect, by connecting in parallel an odd number of serial multi-layer laminate bodies in which a plurality of the single laminate bodies are laminated in the form of serial connection, and arranging in parallel the positive electrode collector electrode plate and negative electrode collector electrode plate at one end side among both ends in the lamination direction of the single laminate body so that the negative electrode collector electrode plate is closer to the outer side than the one end, the negative electrode collector electrode plate and the other end side among both ends in the lamination direction of the single laminate body become the same potential. For this reason, it is possible to assume a configuration not providing an insulation sheet between the negative electrode collector electrode plate, other end side among both ends in the lamination direction of the single laminate body and the inner surface of the outer packaging, and between the negative electrode collector electrode plate and the inner surface of the outer packaging, and thus the number of insulation sheets can be reduced.

### BRIEF DESCRIPTION OF THE DRAWINGS

FIG. 1 is a cross-sectional view representing a bipolar electrode applied to an embodiment of the present invention;

FIG. 2 is a theoretical configurational diagram of a secondary battery made using the bipolar electrode of the present invention;

FIG. 3 is a view for explaining the occurrence status of a potential difference between both positive/negative electrodes of a laminate body of two layers made by laminating two single laminate bodies in series, in the embodiment of the present invention;

FIG. 4 is a view for explaining the occurrence status of a potential difference between both positive/negative electrodes of a laminate body of three layers made by laminating three single laminate bodies in series, in the embodiment of the present invention;

FIG. 5 is a view for explaining the occurrence status of a potential difference between both positive/negative electrodes of a laminate body of four layers made by laminating four single laminate bodies in series, in the embodiment of the present invention;

FIG. 6 is a view for explaining the occurrence status of a potential difference between both positive/negative electrodes of a laminate body of six layers made by laminating six single laminate bodies in series, in the embodiment of the present invention;

FIG. 7 is a view for explaining a configuration connecting in parallel two laminate bodies of two layers made by laminating two single laminate bodies in series, and an occurrence situation of a potential difference between both positive/negative electrodes for every laminate body of two layers, in an embodiment of the present invention;

FIG. 8 is a view for explaining a configuration connecting in parallel two laminate bodies of three layers made by laminating in series three single laminate bodies, and an occurrence situation of the potential difference between both positive/negative electrodes for every laminate body of three layers, in an embodiment of the present invention;

FIG. 9 is a view for explaining a configuration connecting in parallel two laminate bodies of six layers made by laminating in series six single laminate bodies, and an occurrence situation of the potential difference between both positive/negative electrodes for every laminate body of six layers, in an embodiment of the present invention;

FIG. 10 is a view for explaining a configuration connecting in parallel three laminate bodies of six layers made by laminating in series six single laminate bodies, and an occurrence situation of the potential difference between both positive/negative electrodes for every laminate body of six layers, in an embodiment of the present invention;

FIG. 11 is a view for explaining a configuration connecting in parallel four laminate bodies of six layers made by laminating in series six single laminate bodies, and an occurrence situation of the potential difference between both positive/negative electrodes for every laminate body of six layers, in an embodiment of the present invention;

FIG. 12 is a view for explaining a configuration connecting in parallel four laminate bodies of twelve layers made by laminating in series twelve single laminate bodies, and an occurrence situation of the potential difference between both positive/negative electrodes for every laminate body of six layers, in an embodiment of the present invention, and the form of wiring to the positive electrode collector electrode plate and negative electrode collector electrode plate;

FIG. 13 is a view for explaining a configuration connecting in parallel eight laminate bodies of six layers made by laminating in series six single laminate bodies, and an occurrence situation of the potential difference between both positive/negative electrodes for every laminate body of six layers, in an embodiment of the present invention, and the form of wiring to the positive electrode collector electrode plate and negative electrode collector electrode plate;

FIG. 14 is a view for explaining a configuration connecting in parallel twelve laminate bodies of four layers made by laminating in series four single laminate bodies, and an occurrence situation of the potential difference between both positive/negative electrodes for every laminate body of four layers, in an embodiment of the present invention, and the form of wiring to the positive electrode collector electrode plate and negative electrode collector electrode plate;

FIG. 15 is an exploded conceptual view for explaining the physical configuration of a laminate body of a plurality of layers made by laminating in series a plurality of single laminate bodies, in the embodiment of the present invention;

FIG. 16 is a conceptual view after lamination of the laminate bodies in FIG. 15;

FIG. 17 is a view showing a battery pack storing the laminate body of FIG. 16 in an outer packaging;

FIG. 18 is a projection drawing of the laminate of the battery pack of FIG. 17 in a lamination direction;

FIG. 19 is a view for explaining a configuration connecting in parallel four laminate bodies of twelve layers made by laminating in series twelve single laminate bodies, and an occurrence situation of the potential difference between both positive/negative electrodes for every laminate body of twelve layers, and the form of wiring to the positive electrode collector electrode plate and negative electrode collector electrode plate, in an embodiment of the present invention;

FIG. 20 is a view for explaining a configuration connecting in parallel eight laminate bodies of six layers made by laminating in series six single laminate bodies, and an occurrence situation of the potential difference between both positive/negative electrodes for every laminate body of six layers, and the form of wiring to a positive electrode collector electrode plate and negative electrode collector electrode plate, as well as the positive electrode collector electrode and negative electrode collector electrode, in an embodiment of the present invention;

FIG. 21 is a view for explaining a configuration connecting in parallel twelve laminate bodies of four layers made by laminating in series four single laminate bodies, and an occurrence situation of the potential difference between both positive/negative electrodes for every laminate body of four layers, and the form of wiring to a positive electrode collector electrode plate and negative electrode collector electrode plate, as well as the positive electrode collector electrode and negative electrode collector electrode in an embodiment of the present invention;

FIG. 22 is a view for explaining a configuration connecting in parallel five laminate bodies of twelve layers made by laminating in series twelve single laminate bodies, and an occurrence situation of the potential difference between both positive/negative electrodes for every laminate body of twelve layers, and the form of wiring to a positive electrode collector electrode plate and negative electrode collector electrode plate, as well as the positive electrode collector electrode and negative electrode collector electrode, in an embodiment of the present invention;

FIG. 23 is a view for explaining a configuration connecting in parallel nine laminate bodies of six layers made by laminating in series six single laminate bodies, and an occurrence situation of the potential difference between both positive/negative electrodes for every laminate body of six layers, and the form of wiring to a positive electrode collector electrode plate and negative electrode collector electrode plate, as well as the positive electrode collector electrode and negative electrode collector electrode, in an embodiment of the present invention;

FIG. 24 is a view for explaining a configuration connecting in parallel thirteen laminate bodies of four layers made by laminating in series four single laminate bodies, and an occurrence situation of the potential difference between both positive/negative electrodes for every laminate body of four layers, and the form wiring to of a positive electrode collector electrode plate and negative electrode collector electrode plate, as well as the positive electrode collector electrode and negative electrode collector electrode, in an embodiment of the present invention;

FIG. 25 is an exploded conceptual view for explaining the physical configuration of a laminate body of a plurality of layers made by arranging a plurality of single laminate bodies, a positive electrode collector electrode and negative electrode collector electrode, in the embodiment of the present invention;

FIG. 26 is a conceptual view after lamination of the laminate bodies in FIG. 25;

FIG. 27 is a view showing a battery pack storing the laminate body of FIG. 26 in an outer packaging;

FIG. 28 is a projection drawing of the laminate of the battery pack of FIG. 27 in a lamination direction;

FIG. 29 is an exploded conceptual view for explaining the physical configuration of a laminate body of a plurality of layers made by laminating a plurality of single laminate bodies, further arranging the positive electrode collector electrode and negative electrode collector electrode, and arranging external connector terminals at both end parts in the lamination direction, in the embodiment of the present invention;

FIG. 30 is a view showing a battery pack storing the laminate body of FIG. 29 in an outer packaging;

FIG. 31 is a projection drawing of the laminate of the battery pack of FIG. 30 in a lamination direction;

FIG. 32 is a view for explaining a configuration connecting in parallel four laminate bodies of twelve layers made by laminating in series twelve single laminate bodies, and an occurrence situation of the potential difference between both positive/negative electrodes for every laminate body of twelve layers, and another form of wiring to the positive electrode collector electrode plate and negative electrode collector electrode plate, and the midpoint potential connection part, in an embodiment of the present invention;

FIG. 33 is a view for explaining a configuration connecting in parallel eight laminate bodies of six layers made by laminating in series six single laminate bodies, and an occurrence situation of the potential difference between both positive/negative electrodes for every laminate body of six layers, and another form of wiring to the positive electrode collector electrode plate and negative electrode collector electrode plate, as well as the positive electrode collector electrode and negative electrode collector electrode, in an embodiment of the present invention;

FIG. 34 is a view for explaining a configuration connecting in parallel twelve laminate bodies of four layers made by laminating in series four single laminate bodies, and an occurrence situation of the potential difference between both positive/negative electrodes for every laminate body of four layers, and another form of wiring to the positive electrode collector electrode plate and negative electrode collector electrode plate, as well as the positive electrode collector electrode and negative electrode collector electrode, in an embodiment of the present invention;

FIG. 35 is an exploded conceptual view for explaining the physical configuration of a laminate body of a plurality of layers made by laminating a plurality of single laminate bodies, further arranging the positive electrode collector electrode and negative electrode collector electrode, and arranging an insulation sheet, in an embodiment of the present invention;

FIG. 36 is a view showing a battery pack storing the laminate body of FIG. 35 in an outer packaging;

FIG. 37 is a projection drawing of the laminate of the battery pack of FIG. 36 in a lamination direction;

FIG. 38 is a view for explaining a configuration connecting in parallel five laminate bodies of twelve layers made by laminating in series twelve single laminate bodies, and an occurrence situation of the potential difference between both positive/negative electrodes for every laminate body of twelve layers, and another form of wiring to the positive electrode collector electrode plate and negative electrode collector electrode plate, in an embodiment of the present invention;

FIG. 39 is a view for explaining a configuration connecting in parallel nine laminate bodies of six layers made by laminating in series six single laminate bodies, and an occurrence situation of the potential difference between both positive/negative electrodes for every laminate body of six layers, and another form of wiring to the positive electrode collector electrode plate and negative electrode collector electrode plate, as well as the positive electrode collector electrode and negative electrode collector electrode, in an embodiment of the present invention;

FIG. 40 is a view for explaining a configuration connecting in parallel thirteen laminate bodies of four layers made by laminating in series four single laminate bodies, and an occurrence situation of the potential difference between both positive/negative electrodes for every laminate body of four layers, and another form of wiring to the positive electrode collector electrode plate and negative electrode collector electrode plate, as well as the positive electrode collector electrode and negative electrode collector electrode, in an embodiment of the present invention;

FIG. 41 is an exploded conceptual view for explaining the physical configuration of another configurational example of a laminate body of a plurality of layers made by laminating a plurality of single laminate bodies, further arranging a positive electrode collector electrode and negative electrode collector electrode, and arranging an insulation sheet, in an embodiment of the present invention;

FIG. 42 is a view showing a battery pack storing the laminate body of FIG. 41 in an outer packaging;

FIG. 43 is a projection drawing of the laminate of the battery pack of FIG. 42 in a lamination direction;

FIG. 44 is an exploded conceptual view for explaining the physical configuration of another configurational example of a laminate body of a plurality of layers made by laminating a plurality of single laminate bodies, further arranging a positive electrode collector electrode and negative electrode collector electrode, and arranging an insulation sheet, in an embodiment of the present invention;

FIG. 45 is a view showing a battery pack storing the laminate body of FIG. 44 in an outer packaging;

FIG. 46 is a projection drawing of the laminate of the battery pack of FIG. 45 in a lamination direction;

FIG. 47 is a view for explaining a configuration connecting in parallel five laminate bodies of twelve layers made by laminating in series twelve single laminate bodies, and an occurrence situation of the potential difference between both positive/negative electrodes for every laminate body of twelve layers, and another form of wiring to the positive electrode collector electrode plate and negative electrode collector electrode plate, in an embodiment of the present invention;

FIG. 48 is a view for explaining a configuration connecting in parallel nine laminate bodies of six layers made by laminating in series six single laminate bodies, and an occurrence situation of the potential difference between both positive/negative electrodes for every laminate body of six layers, and another form of wiring to the positive electrode collector electrode plate and negative electrode collector electrode plate, as well as the positive electrode collector electrode and negative electrode collector electrode, in an embodiment of the present invention;

FIG. 49 is a view for explaining a configuration connecting in parallel thirteen laminate bodies of four layers made by laminating in series four single laminate bodies, and an occurrence situation of the potential difference between both positive/negative electrodes for every laminate body of four layers, and another form of wiring to the positive electrode collector electrode plate and negative electrode collector electrode plate, as well as the positive electrode collector electrode and negative electrode collector electrode, in an embodiment of the present invention;

FIG. 50 is a view showing a solid-state battery configured by normal electrodes and solid electrolyte;

FIG. 51 is a view for explaining the form of wiring to the positive electrode collector electrode plate and negative electrode collector electrode plate of a power generation unit made by connecting in parallel a plurality of the solid-state batteries of FIG. 50; and

FIG. 52 is a view for explaining the form of wiring to the positive electrode collector electrode plate and negative electrode collector electrode plate, as well as a middle point connection part of a power generation unit made by connecting in series a plurality of partial power generation units made by connecting in parallel a plurality of the solid-state batteries of FIG. 50.

### DETAILED DESCRIPTION OF THE INVENTION

Herein, an embodiment of the present invention will be explained while referencing the drawings. It should be noted that, in each of the drawings referenced below, the same reference symbol is attached to the corresponding part, and in the explanations of these, the previous explanation of the corresponding part with the same reference symbol will be invoked as appropriate. A secondary battery made using a bipolar electrode as an embodiment of the present invention is configured to include a bipolar electrode and a normal electrode. FIG. 50 is a view showing a solid-state battery 1 configured by normal electrodes and solid electrolyte. This solid-state battery 1 is configured by a positive electrode normal electrode 3 being laminated on the side of one surface and a negative electrode normal electrode 4 being laminated on the side of another surface of a plate-like solid electrolyte layer 2.

The positive electrode normal electrode 3 is a normal electrode of a form formed as a pole of positive polarity by coating a positive electrode mixture 6 containing a positive electrode active material such as lithium cobalt oxide and lithium phosphate, and further a conductive aid and binder, on both sides of one positive electrode sheet-like collector 5, which is a current collector foil such as aluminum.

The negative electrode normal electrode 4 is a normal electrode of a form formed as a pole of positive polarity by coating a negative electrode mixture 8 containing a positive electrode active material such as graphite and lithium titanate, and further a binder, on both sides of one negative electrode sheet-like collector 7, which is a current collector foil such as copper.

The solid-state battery 1 generates electromotive force E between the positive electrode sheet-like collector 5 and negative electrode sheet-like collector 7. The solid-state battery 1 is a battery configuring one power generation element in which a plurality of serial connection bodies connected in series electrically with the same type of solid-state batteries and producing a predetermined electromotive force is connected in parallel. The serial connection body of a solid-state battery constituting such a power generation element, and the parallel connection body of this serial connection body constitute a partial power generation element relative to the aforementioned such power generation element.

It should be noted that, in the present disclosure, between the positive electrode sheet-like collector 5 and negative electrode sheet-like collector 7 generating the electromotive force E shall be counted as one electrode plane (p=1). In addition, the parallel connection of this electrode plane shall be called p-number parallel.

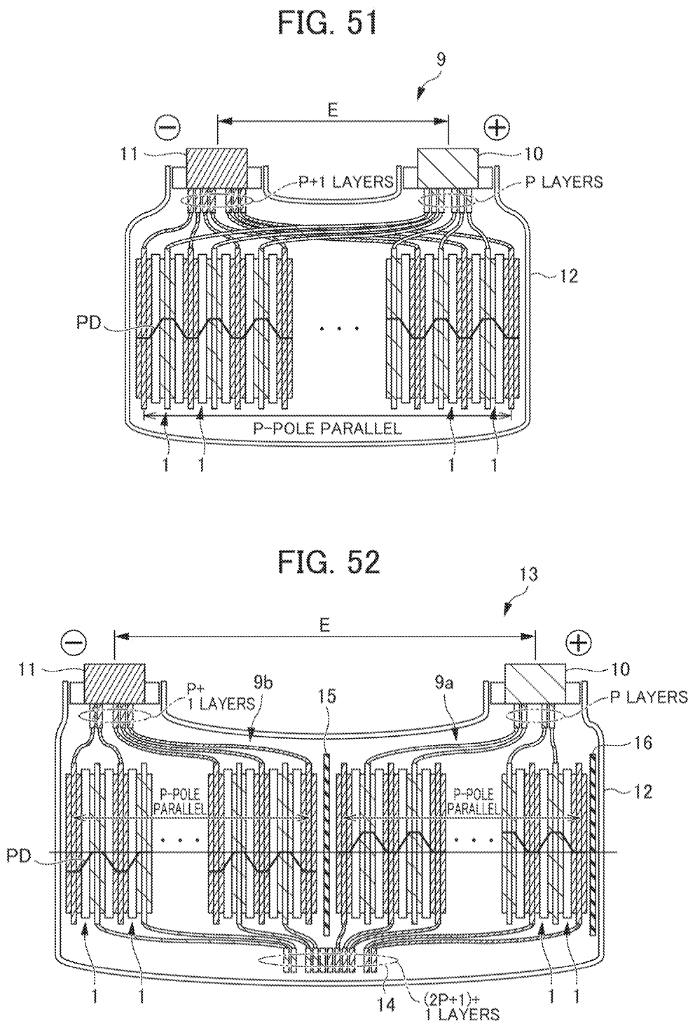

FIG. 51 is a view for explaining the form of wiring to the positive electrode collector electrode plate (positive electrode tab) 10 and negative electrode collector electrode plate (negative electrode tab) 11 in a power generation unit made by connecting a plurality of the solid-state battery of FIG. 50 in parallel. In the power generation unit 9 of FIG. 51, P-number of solid-state batteries 1 are electrically connected in parallel between the positive electrode tab 10 and negative electrode tab 11 for supplying output power to outside. This connection state is noted as p-pole parallel in the drawings. In FIG. 51, the potential difference PD between each solid-state battery 1 is conceptually shown by the bold solid line at an intermediate position in the vertical direction of each solid-state battery 1. Due to being a parallel connection, the electromotive force E produced between the positive electrode tab 10 and negative electrode tab 11 equals the electromotive force of each solid-state battery 1. In addition, due to being a parallel connection, P-number of wires are connected to the positive electrode tab 10, and P+1-number of wires are connected to the negative electrode tab 11, as illustrated. This power generation unit 9 can be conceptualized as a partial power generation unit further constituting a high-voltage power generation unit in multiple layers by serial or parallel connection of the same type of power generation units. It should be noted that the power generation unit 9 is accommodated in the outer packaging 12 which is a laminate.

FIG. 52 is a view for explaining the form of wiring to the positive electrode tab and negative electrode tab, as well as the intermediate potential connection part, in another power generation unit made by connecting in series a plurality of partial power generation units made by connecting in parallel a plurality of the solid-state batteries of FIG. 51. This power generation unit 13 is a unit made by connecting two in series of this partial power generation unit, with a power generation unit of p-pole parallel which is similar to the power generation unit 9 of FIG. 50 as the partial power generation unit. The value for the electromotive force E between the positive electrode tab 10 and negative electrode tab 11 of the power generation unit 13 is twice the electromotive force E of the power generation unit 9 of FIG. 51. The numbers of wires of the positive electrode tab 10 and negative electrode tab 11 are P and P+1, which are the same numbers as the power generation unit 9 of FIG. 51. On the other hand, the number of wires in the midpoint potential connection unit 14 when connecting in series two of the partial power generation units becomes (2P+1)+1. It should be noted that the power generation unit 13 is stored in the outer packaging 12 which is a laminate. An intermediate insulation sheet 15 is interposed between the partial power generation unit 9a on the side of the positive electrode tab 10 and the partial power generation unit 9b on the side of the negative electrode tab 11, and an outer packaging inner surface insulation sheet 16 is interposed between the partial power generation unit 9a and outer packaging 12.

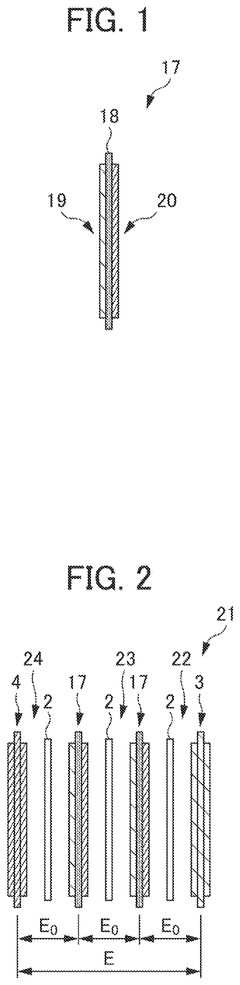

FIG. 1 is a cross-sectional view representing a bipolar electrode applied to the embodiment of the present invention. The bipolar electrode 17 is an electrode in which a positive electrode mixture slurry 19 to become the positive electrode of a polarizable electrode was formed on one surface of one sheet-like collector (current collector foil) 18, and a negative electrode mixture slurry 20 to become a negative electrode of a polarizable electrode was formed on another surface thereof.

FIG. 2 is a theoretical configurational drawing of a secondary battery made using the bipolar electrode of the present invention. In FIG. 2, the secondary battery 21 which is one unit battery is configured as a multi-layer laminate body made by laminating in series a plurality of single laminate bodies. In detail, the positive electrode normal electrode 3 is provided to the outermost end part on the positive electrode side, and the negative electrode normal electrode 4 is provided to the outermost end part on the negative electrode side of the secondary battery 21. In the present example, two bipolar electrodes 17 are provided between the positive electrode normal electrode 3 and the negative electrode normal electrode 4. Solid electrolyte layers 2 are respectively laminated to be sandwiched between the positive electrode normal electrode 3 and one bipolar electrode 17, between the two bipolar electrode 17, and between the other one bipolar electrode 17 and negative electrode normal electrode 4, from the side of the positive electrode normal electrode 3 towards the side of the negative electrode normal electrode 4.

In other words, the partial unit battery 22 of a first form is configured so that one solid electrolyte layer 2 is sandwiched by the positive electrode normal electrode 3 and one bipolar electrode 17. The partial unit battery 23 of a second form is configured so that one solid electrolyte layer 2 is sandwiched by the two bipolar electrodes 17 of one bipolar electrode 17 and another bipolar electrode 17. In addition, a partial unit battery 24 of a third form is configured so that one solid electrolyte layer 2 is sandwiched by the other one bipolar electrode 17 and the negative electrode normal electrode 4.

The electromotive force of each partial unit battery sequentially laminating, from the side of the negative electrode normal electrode 4 towards the side of the positive electrode normal electrode 3, the partial unit battery 24 of the third form, the partial unit battery 23 of the second form and the partial unit battery 22 of the first form are equal at E0 (for example, 3.7 volts). In addition, the partial unit battery 24 of the third form, partial unit battery 23 of the second form and partial unit battery 22 of the first form are laminated in order from the side of the negative electrode normal electrode 4 towards the side of the positive electrode normal electrode 3, and thereby constitute the serial connection body. Therefore, the electromotive force E of the secondary battery (unit battery) 21 becomes E0×3 (for example, 11.1 volts).

Hereinafter, the partial unit battery 22 of the first form, the partial unit battery 23 of the second form, and the partial unit battery 24 of the third form are collectively called a single laminate body 25 as appropriate. The single laminate 25 is a partial power generation element constituting a power generation element of a secondary battery by itself or as an assembly thereof. The number of single laminate bodies 25 is equal to the number of solid electrolyte layers 2 sandwiched by two electrodes. In the present disclosure, one single laminate body 25 is counted as one pole as appropriate hereinafter.

In the present embodiment, as understood by referencing FIG. 2, when defining the series number (series pole number) of the serial connection body of single laminate bodies 25 as s (natural number of 2 or greater), the number of bipolar electrodes included in this serial connection body is s−1, the number p(+) of positive electrode normal electrodes is 1, and the number p(−) of negative electrode normal electrodes is 1.

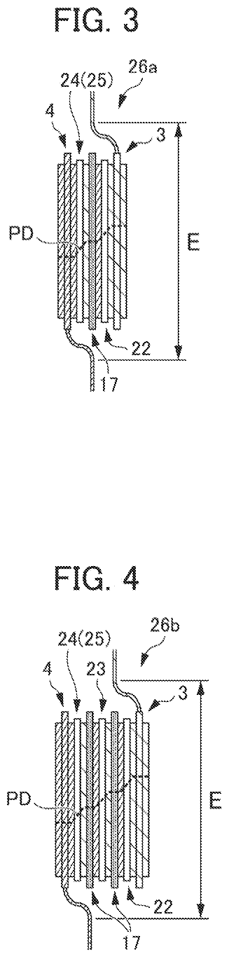

FIGS. 3 to 6 are respectively views showing examples in which the series number of partial unit batteries in the secondary battery (unit battery) 21 are different. In FIGS. 3 to 6, the corresponding parts with the aforementioned FIG. 2 are shown by assigning the same reference symbol. In FIGS. 3 to 6, the potential difference PD between each partial unit battery is conceptually shown by a bold solid line at an intermediate position in the vertical direction of each partial unit battery. In the case of any of FIGS. 3 to 6 as well, the single laminate bodies 25 which is a constituent element of the multi-layer laminate body are laminated in a direction of polarity configuring the serial connection, between the positive electrode normal electrode 3 and negative electrode normal electrode 4, thereby configuring the serial partial power generation element 26 (26a, 26b, 26c, 26d).

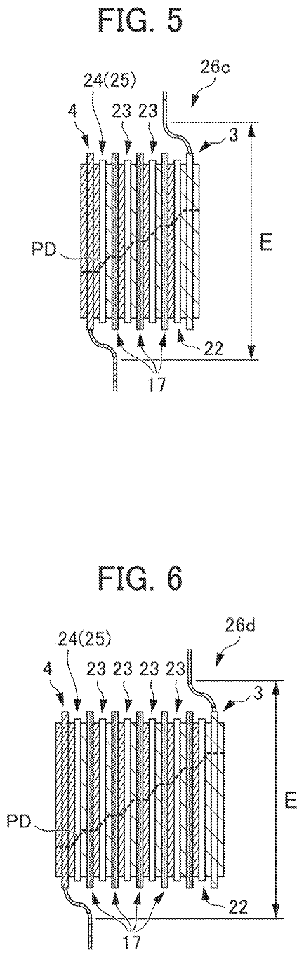

In the case of FIG. 3, a serial partial power generation element 26a which is a laminate body of two layers made by laminating in series two of the single laminates 25 is configured. The occurrence status of the potential difference corresponding to the lamination layer of the single laminate 25 within the serial partial power generation element 26a is shown by the bold line as potential difference PD. In the case of FIG. 4, the serial partial power generation element 26b which is laminate body of three layers made by laminating in series three of the single laminate bodies 25 is configured. The occurrence status of the potential difference corresponding to the lamination layer of the single laminate 25 within the serial partial power generation element 26b is shown by the bold line as potential difference PD. In the case of FIG. 5, the serial partial power generation element 26c which is laminate body of four layers made by laminating in series four of the single laminate bodies 25 is configured. The occurrence status of the potential difference corresponding to the lamination layer of the single laminate 25 within the serial partial power generation element 26c is shown by the bold line as potential difference PD. In the case of FIG. 6, the serial partial power generation element 26d which is laminate body of six layers made by laminating in series six of the single laminate bodies 25 is configured. The occurrence status of the potential difference corresponding to the lamination layer of the single laminate 25 within the serial partial power generation element 26e is shown by the bold line as potential difference PD.

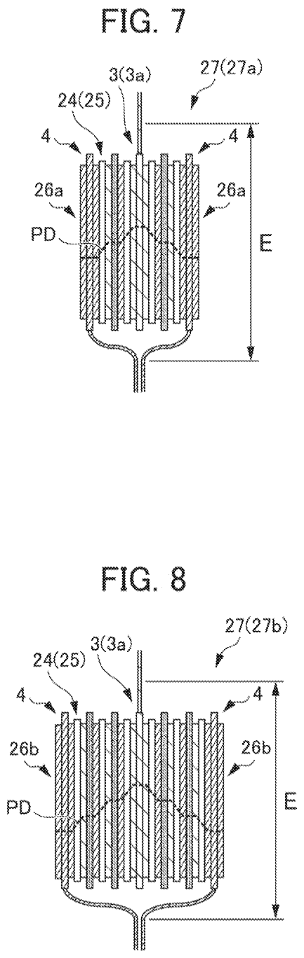

FIGS. 7 to 9 each show a parallel connection body of a first form with one positive electrode normal electrode as the positive electrode collector electrode, in which the serial partial power generation element is joined between the positive collector electrode and two negative electrode normal electrodes corresponding thereto, to have reversed polarity, sandwiching the positive collector electrode, and the serial partial power generation element is connected in parallel between the positive collector electrode and two negative electrode normal electrodes.

In the case of FIG. 7, with one positive electrode normal electrode 3 as the positive collector electrode 3a, the serial partial power generation element 26a of FIG. 3 is connected between the two negative electrode normal electrodes 4, 4 corresponding to the positive collector electrode 3a, with reversed polarity, to sandwich the positive collector electrode 3a. The parallel connection body 27 (27a) of the first form in which the serial partial power generation elements 26a are connected in parallel between the positive collector electrode 3a and the two negative electrode normal electrodes 4, 4 is configured by this joining. The occurrence status of the potential difference corresponding to the lamination layers of the single laminate bodies 25 within the parallel connection body 27a of the first form is shown by the bold line as potential difference PD. Connections in the case of FIG. 7 can be seen as being a connection body made by connecting in parallel two groups of a two-pole series.

In the case of FIG. 8, with one positive electrode normal electrode 3 as the positive collector electrode 3a, the serial partial power generation element 26b of FIG. 4 is connected between the two negative electrode normal electrodes 4, 4 corresponding to the positive collector electrode 3a, with reversed polarity, to sandwich the positive collector electrode 3a. The parallel connection body 27 (27b) of the first form in which the serial partial power generation elements 26b are connected in parallel between the positive collector electrode 3a and the two negative electrode normal electrodes 4, 4 is configured by this joining. The occurrence status of the potential difference corresponding to the lamination layers of the single laminate bodies 25 within the parallel connection body 27b of the first form is shown by the bold line as potential difference PD. Connections in the case of FIG. 8 can be seen as being a connection body made by connecting in parallel two groups of a three-pole series.

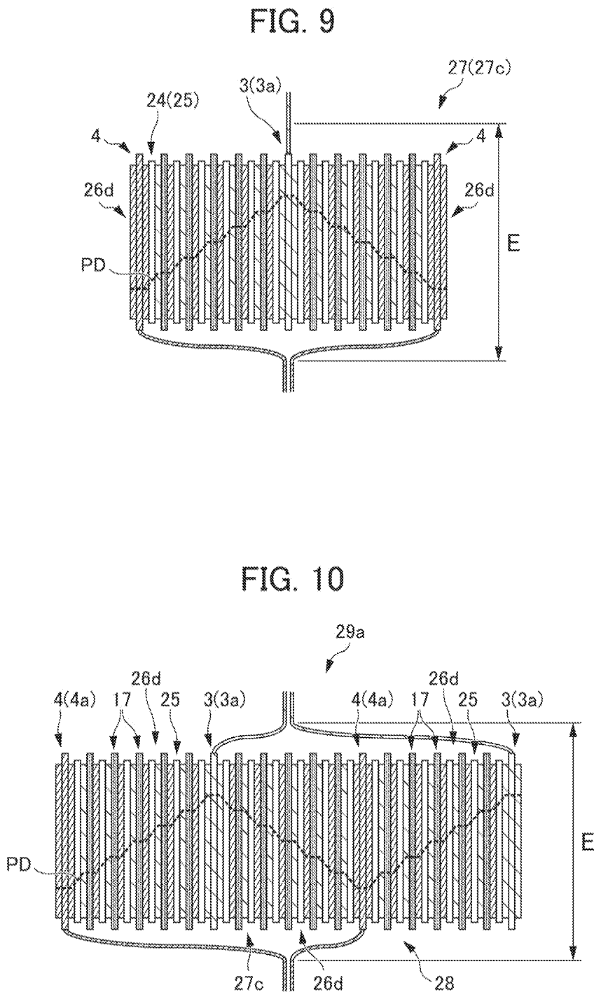

In the case of FIG. 9, with one positive electrode normal electrode 3 as the positive collector electrode 3a, the serial partial power generation element 26d of FIG. 6 is connected between the two negative electrode normal electrodes 4, 4 corresponding to the positive collector electrode 3a, with reversed polarity, to sandwich the positive collector electrode 3a. The parallel connection body 27 (27c) of the first form in which the serial partial power generation elements 26d are connected in parallel between the positive collector electrode 3a and the two negative electrode normal electrodes 4, 4 is configured by this joining. The occurrence status of the potential difference corresponding to the lamination layers of the single laminate bodies 25 within the parallel connection body 27c of the first form is shown by the bold line as potential difference PD. Connections in the case of FIG. 9 can be seen as being a connection body made by connecting in parallel two groups of a six-pole series.

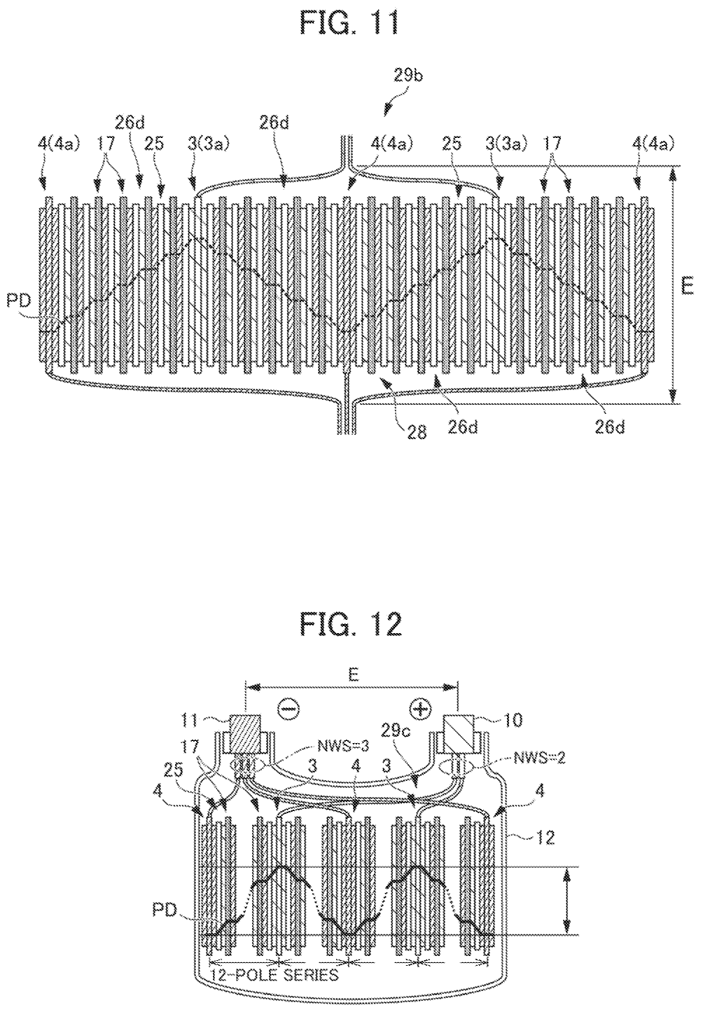

FIGS. 10 and 11 respectively show a parallel connection body made by connecting in parallel the serial partial power generation element 26d of FIG. 6 and the parallel connection body 27c of the first form of FIG. 9. These parallel connection bodies can be seen as being a combination of the aforementioned parallel connection body 27 of the first form, and a parallel connection body 28 of a second form which is a different form than this.

Parallel connection body 28 of the second form is a connection body with one negative electrode normal electrode 4 as the negative collector electrode 4a, in which the serial partial power generation element 26 is joined with reversed polarity sandwiching the negative collector electrode 4a, between the negative collector electrode 4a and two positive electrode normal electrodes 3, 3 corresponding thereto. In other words, the parallel connection body 28 of the second form is a connection body in which the serial partial power generation element 26 is connected in parallel between the negative collector electrode 4a and two positive electrode normal electrodes 3, 3.

The case of FIG. 10 is a configuration connecting in parallel three laminate bodies of six layers made by laminating in series six single laminate bodies, and can be seen as being a connection body made by connecting in parallel three groups of a six-pole series. In addition, it can be seen as being a composite parallel connection body 29 (29a) made by combining the aforementioned parallel connection body 28 of the second form establishing one negative electrode normal electrode 4 as the negative collector electrode 4a, with the parallel connection body 27c of the first form in FIG. 9. In this case, the composite parallel connection body 29a has in the common the serial partial power generation element 26d between the positive collector electrode 3a or negative collector electrode 4a, and one of the negative common electrode 4 or positive common electrode 3. The occurrence status of the potential difference corresponding to the lamination layer of the single laminate body 25 within the composite parallel connection body 29a is shown by the bold line as potential difference PD.

The case of FIG. 11 is a configuration connecting in parallel four laminate bodies of six layers made by laminating six single laminate bodies in series, and can be seen as being a connection body made by connecting in parallel four groups of six-pole series. In addition, it can be seen as being a composite parallel connection body 29 (29b) made by joining the parallel connection body 27c of the first form in FIG. 9 with one negative electrode normal electrode 4, i.e. negative collector electrode 4a, as a joining part, in reverse polarity to this joining part. In this case as well, the composite parallel connection body 29b has in the common the serial partial power generation element 26d between the positive collector electrode 3a or negative collector electrode 4a, and one of the negative common electrode 4 or positive common electrode 3. In addition, it can be seen that the aforementioned parallel connection body 28 of the second form is partially configured around the negative collector electrode 4a, which is the one negative electrode normal electrode 4. The occurrence status of the potential difference corresponding to the lamination layer of the single laminate body 25 within the composite parallel connection body 29b is shown by the bold line as potential difference PD.

As understood by referencing FIGS. 7 to 11, in the embodiment of the present invention, when defining the series number (series pole number) of the serial connection body of single laminate bodies 25 as s (natural number of 2 or greater), and the parallel group number as p (natural number of 2 or greater), the number of solid electrolyte layers contained in the series and parallel connection body is s×p. The number of bipolar electrodes is (s−1)×p irrespective of p being an even number or odd number. The number p(+) of the positive electrode normal electrode is p/2 (when p is an even number) or (p+1)/2 (when p is an odd number). The number p(−) of the negative electrode normal electrode is p/2+1 (when p is an even number) or (p+1)/2 (when p is an odd number). In other words, irrespective of whether p is an even number or odd number, the total number p(+)+p(−) of the number p(+) of the positive electrode normal electrodes and the number p(−) of negative electrode normal electrodes becomes s×p+1.

In the case of the total number s×p of electrodes being identical, and the number (pole number) of single laminate bodies being n, the total number of electrode plates conventionally will be {s×(p+1)}×n; however, in the embodiment of the present invention, it becomes {s×p+1}×n.

In addition, in the embodiment of the present invention from FIGS. 7 to 11, since the serial partial power generation elements are joined with reverse polarity sandwiching the positive electrode collector electrode, between the positive electrode collector electrode and two of the negative electrode normal electrodes corresponding thereto, insulation between the parallel electrode plates is unnecessary. Furthermore, welded plate number of wires to the positive electrode and negative electrode tabs outputting the electromotive force of the storage battery to outside is small. This point will be described in detail below.

FIGS. 12 to 14 are each diagrams for explaining the configuration further connecting in parallel a plurality of laminate bodies made by laminating in series a plurality of single laminate bodies and the occurrence status of the potential difference between both positive and negative electrodes for each of the plurality of laminate bodies, as well as the form of wiring to the positive electrode collector electrode plate and negative electrode 1 collector electrode plate.

FIG. 12 is a configuration connecting in parallel four laminate bodies of twelve layers mad by laminating in series twelve of the single laminate bodies, and can be seen as being a composite parallel connection body 29 (29c) made by connecting in parallel four groups of twelve-pole series. The occurrence status of the potential difference corresponding to the lamination layer of the single laminate bodies 25 within the composite parallel connection body 29c is shown by the bold line as potential difference PD. The form of wiring to the positive electrode 10 connected with each positive electrode collector electrode plate and the form of wiring to the negative electrode tab 11 connected with each negative electrode collector electrode plate are shown as the number of welded sheets (abbreviated as NWS) of wiring. The output electromotive force E is obtained between the positive electrode tab 10 and negative electrode tab 11. In the case of the twelve-pole series of FIG. 12 being a four-group parallel connection, NWS is 2 at the positive electrode tab 10, and NWS is 3 at the negative electrode tab 11. It should be noted that the composite parallel connection body 29c is stored in the outer packaging 12 which is a laminate.

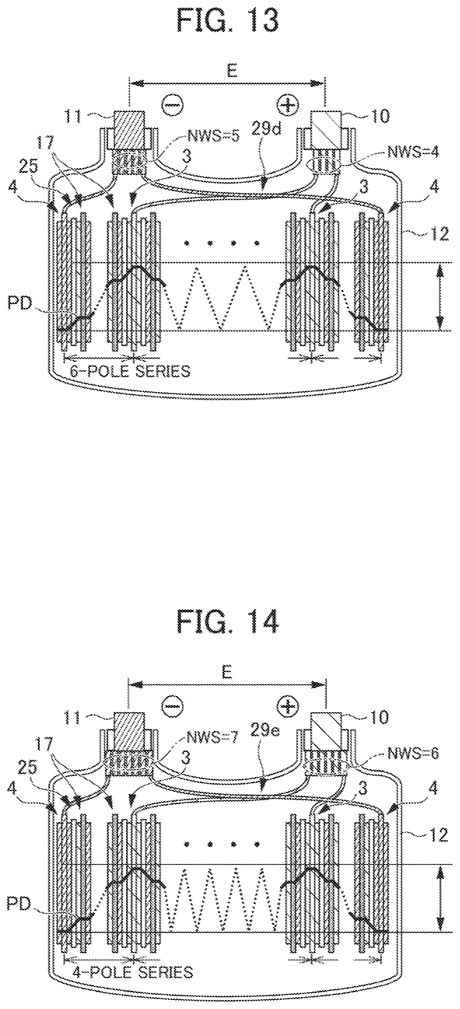

FIG. 13 is a configuration which connects in parallel eight of the laminate bodies of six layers made by laminating six single laminate bodies in series, and can be seen as being the composite parallel connection body 29 (29d) made by connecting four groups in parallel of six-pole series. The occurrence status of the potential difference corresponding to the lamination layer of the single laminate bodies 25 within the composite parallel connection body 29d is shown by the bold line as potential difference PD. The form of wiring to the positive electrode 10 connected with each positive electrode collector electrode plate and the form of wiring to the negative electrode tab 11 connected with each negative electrode collector electrode plate are shown as the number of welded sheets (abbreviated as NWS) of wiring. The output electromotive force E is obtained between the positive electrode tab 10 and negative electrode tab 11. In the case of the six-pole series of FIG. 13 being an eight-group parallel connection, NWS is 4 in the positive electrode tab 10, and NWS is 5 in the negative electrode tab 11. It should be noted that the composite parallel connection body 29d is stored in the outer packaging 12 which is a laminate.

FIG. 14 is a configuration which connects in parallel twelve of the laminate bodies of four layers made by laminating four single laminate bodies in series, and can be seen as being the composite parallel connection body 29 (29e) made by connecting twelve groups in parallel of four-pole series. The occurrence status of the potential difference corresponding to the lamination layer of the single laminate bodies 25 within the composite parallel connection body 29e is shown by the bold line as potential difference PD. The form of wiring to the positive electrode 10 connected with each positive electrode collector electrode plate and the form of wiring to the negative electrode tab 11 connected with each negative electrode collector electrode plate are shown as the number of welded sheets (abbreviated as NWS) of wiring. The output electromotive force E is obtained between the positive electrode tab 10 and negative electrode tab 11. In the case of four-pole series of FIG. 14 being a twelve-group parallel connection, NWS is 6 in the positive electrode tab 10, and NWS is 6 also in the negative electrode tab 11. It should be noted that the composite parallel connection body 29e is stored in the outer packaging 12 which is a laminate.

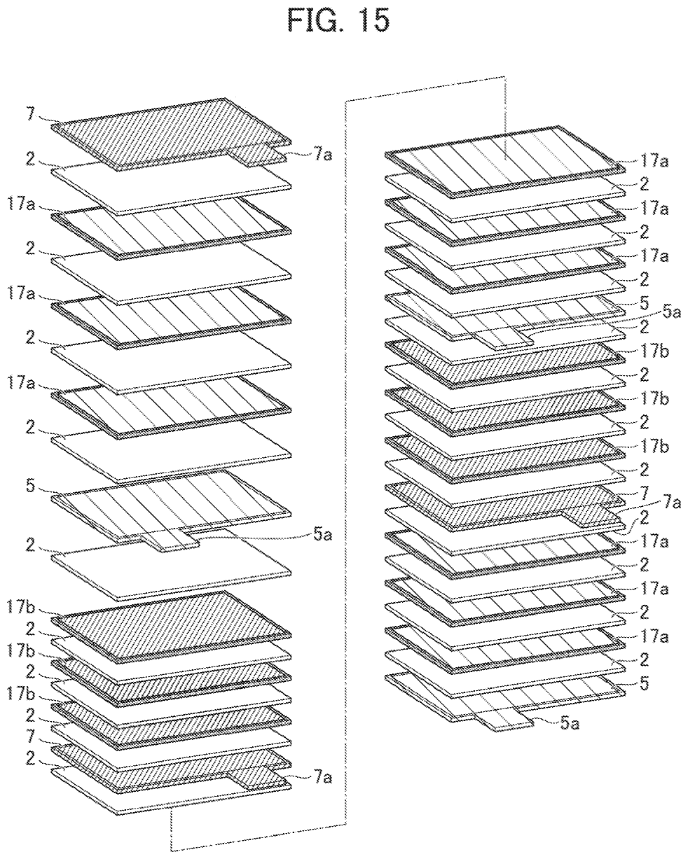

FIG. 15 is an exploded conceptual view for explaining the physical configuration of a laminate body of a plurality of layers made by laminating a plurality of single laminate bodies in series. In the example of the illustration, the negative electrode sheet-like collector 7 having the negative electrode 7a is positioned at the topmost layer. The negative electrode sheet-like collector 7 is one form of the negative electrode normal electrode 4. The single laminate body (partial power generation element) composed of the solid electrolyte layer 2, bipolar electrode 17a of the first form and the solid electrolyte layer 2 is repeatedly laminated as in the illustration sequentially towards the bottom layer from the negative electrode sheet-like collector 7.

The bipolar electrode 17a of the first form is a bipolar electrode of a form in which the positive electrode material (positive electrode mixture slurry 19) is coated on the upper layer surface side in the lamination direction of the single laminate body of FIG. 15, and the negative electrode material (negative electrode mixture slurry 20) is coated on the lower layer surface side.

The positive electrode sheet-like collector 5 having the positive electrode 5a is laminated at a place where repetition ends of lamination layers of single laminate body (partial power generation element) composed of the bipolar electrode 17a of the first form and the solid electrolyte layer 2. The single laminate (partial power generation element) composed by the bipolar electrode 17b of the second form and the solid electrolyte layer 2 are repeatedly laminated as in the illustrations, from the positive electrode sheet-like collector 5 further towards sequential lower layers.

The bipolar electrode 17b of the second form is a bipolar electrode of a form in which the negative electrode material (negative electrode mixture slurry 20) is coated on the upper layer surface side in the lamination direction of the single laminate body in FIG. 15, and the positive electrode material (positive electrode mixture slurry 19) is coated on the lower layer surface side.

The negative electrode sheet-like collector 7 having the negative electrode 7a is laminated at a place where repetition ends of lamination of the single laminate body (partial power generation element) composed of the bipolar electrode 17b of the second form and the solid electrolyte layer 2. Lamination is repeated as mentioned above from the negative electrode sheet-like collector 7 having the negative electrode 7a laminated again, further towards the sequential lower layers, as illustrated, and the positive electrode sheet-like collector 5 having the positive electrode 5a is laminated on the bottom most layer.

FIG. 16 is a conceptual diagram representing the form after lamination of the laminate body of FIG. 15. As illustrated, the positive electrode 5a of each positive electrode sheet-like collector 5 overlaps at a projection position of the laminate body in the lamination direction. Similarly, the negative electrode 7a of each negative electrode sheet-like collector 7 overlaps at the projection position of the laminate body in the lamination direction.

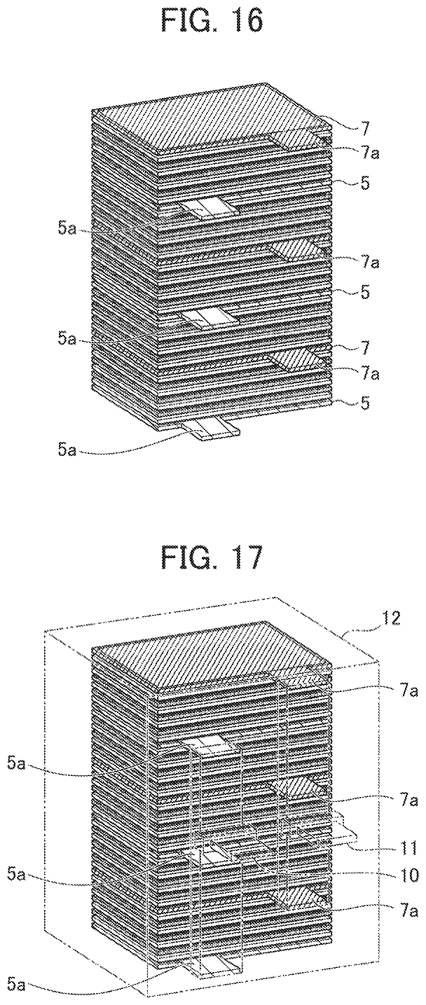

FIG. 17 is a view showing a battery pack made by storing the laminate body of FIG. 16 in the outer packaging. In the battery pack of FIG. 17, the positive electrodes 5a of each positive electrode sheet-like collector 5 which is at a position overlapping at the projection position of the laminate bodies in the lamination direction as in FIG. 16 are connected in parallel by cell-internal collector conductor which is illustrated with virtual lines, then collected at the positive electrode tab 10, and led outside of the outer packaging 12. Similarly, the negative electrodes 7a of each negative electrode sheet-like collector 7 which is at a position overlapping in the projection position of the laminate body in the lamination direction are connected in parallel by a cell-internal collector conductor which is illustrated with virtual lines, then collected at the negative electrode tab 11, and led outside of the outer packaging 12.

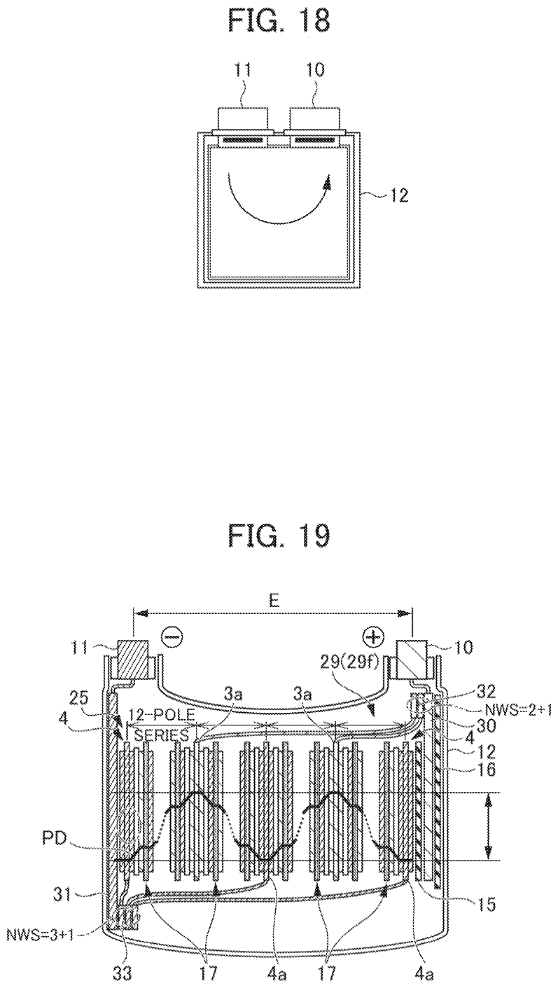

FIG. 18 is a projection view in the lamination direction of laminate bodies of the battery pack in FIG. 17. As illustrated, the positive electrode tab 10 and negative electrode tab 11 are led in parallel to outside from the same lateral surface of the rectangular outer packaging 12. The arrow in FIG. 18 conceptually represents the direction of the electrical current.

FIG. 19 is a configuration which connects in parallel four of the laminate bodies of twelve layers made by laminating twelve single laminate bodies 25 in series, and can be seen as being the composite parallel connection body 29 (29f) made by connecting four groups in parallel of twelve-pole series. In the case of FIG. 19, the positive electrode collector electrode plate 30 and the negative electrode collector electrode plate 31 are arranged at both ends in the lamination direction of the single laminate bodies 25. The conductors on the positive electrode side for connecting in parallel the laminate body of twelve layers are brought together at the positive electrode concentration connection part 32 and welded to the positive electrode collector electrode plate 30. In addition, the conductors on the negative electrode side for connecting in parallel the laminate body of twelve layers are brought together at the negative electrode concentration connection part 33 and welded to the negative electrode collector electrode plate 31. The composite parallel connection body 29f is accommodated in the outer packaging 12 which is a laminate. An outer packaging inner surface insulation sheet 16 is arranged between the positive electrode collector electrode plate 30 and the outer packaging 12. In addition, an intermediate insulation sheet 15 is arranged between the positive electrode collector electrode plate 30 and the negative electrode collector electrode 4a closest thereto.

The occurrence status of the potential difference corresponding to the lamination layer of the single laminate 25 within the serial parallel connection body 29f is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the twelve-pole series of FIG. 19 being a four-group parallel connection, NWS is 2+1 at the positive electrode tab 10, and NWS is 2+1 at the negative electrode tab 11. The output electromotive force E is obtained between the positive electrode tab 10 and negative electrode tab 11.

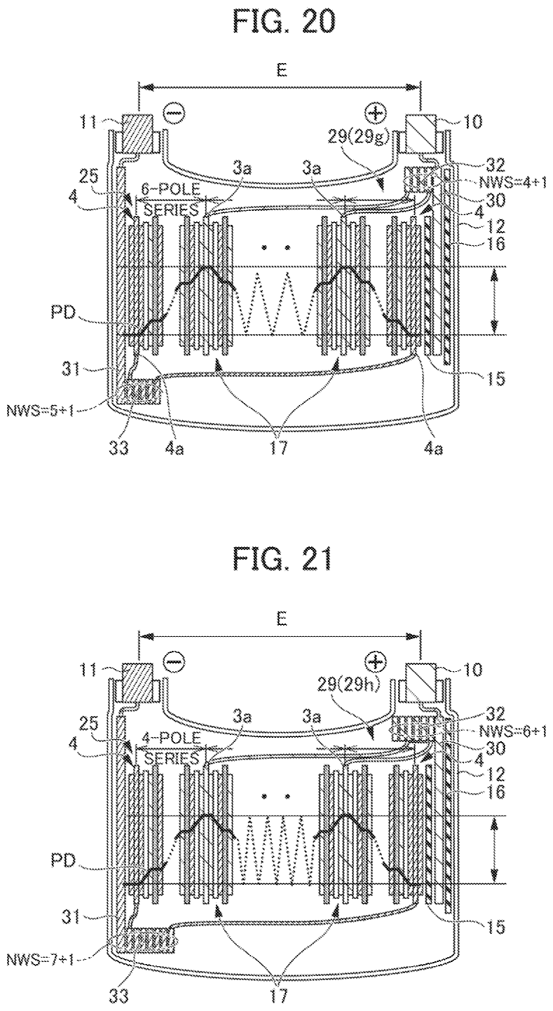

FIG. 20 is a configuration which connects in parallel eight of the laminate bodies of six layers made by laminating six single laminate bodies 25 in series, and can be seen as being the composite parallel connection body 29 (29g) made by connecting eight groups in parallel of six-pole series. In the case of FIG. 20, the positive electrode collector electrode plate 30 and the negative electrode collector electrode plate 31 are arranged at both ends in the lamination direction of the single laminate body 25. The conductors on the positive electrode side for connecting in parallel the laminate body of six layers are brought together at the positive electrode concentration connection part 32 and welded to the positive electrode collector electrode plate 30. In addition, the conductors on the negative electrode side for connecting in parallel the laminate body of six layers are brought together at the negative electrode concentration connection part 33 and welded to the negative electrode collector electrode plate 31. The composite parallel connection body 29g is accommodated in the outer packaging 12 which is a laminate. An outer packaging inner surface insulation sheet 16 is arranged between the positive electrode collector electrode plate 30 and the outer packaging 12. In addition, an intermediate insulation sheet 15 is arranged between the positive electrode collector electrode plate 30 and the negative electrode collector electrode 4a closest thereto.

The occurrence status of the potential difference corresponding to the lamination layer of the single laminate bodies 25 within the composite parallel connection body 29g is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the six-pole series of FIG. 20 being an eight-group parallel connection, NWS is 4+1 at the positive electrode tab 10, and NWS is 5+1 at the negative electrode tab 11. The output electromotive force E is obtained between the positive electrode tab 10 and negative electrode tab 11.

FIG. 21 is a configuration which connects in parallel twelve of the laminate bodies of four layers made by laminating four single laminate bodies 25 in series, and can be seen as being the composite parallel connection body 29 (29h) made by connecting twelve groups in parallel of four-pole series. In the case of FIG. 21, the positive electrode collector electrode plate 30 and the negative electrode collector electrode plate 31 are arranged at both ends in the lamination direction of the single laminate body 25. The conductors on the positive electrode side for connecting in parallel the laminate body of four layers are brought together at the positive electrode concentration connection part 32 and welded to the positive electrode collector electrode plate 30. In addition, the conductors on the negative electrode side for connecting in parallel the laminate body of twelve layers are brought together at the negative electrode concentration connection part 33 and welded to the negative electrode collector electrode plate 31. The composite parallel connection body 29h is accommodated in the outer packaging 12 which is a laminate. An outer packaging inner surface insulation sheet 16 is arranged between the positive electrode collector electrode plate 30 and the outer packaging 12. In addition, an intermediate insulation sheet 15 is arranged between the positive electrode collector electrode plate 30 and the negative electrode collector electrode 4a closest thereto.

The occurrence status of the potential difference corresponding to the lamination layer of the single laminate bodies 25 within the composite parallel connection body 29h is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the four-pole series of FIG. 21 being a twelve-group parallel connection, NWS is 6+1 at the positive electrode tab 10, and NWS is 7+1 at the negative electrode tab 11. The output electromotive force E is obtained between the positive electrode tab 10 and negative electrode tab 11.

In the embodiments of FIGS. 19 to 21, it is possible to select various combinations of output voltage and current capacity with the same thickness size.

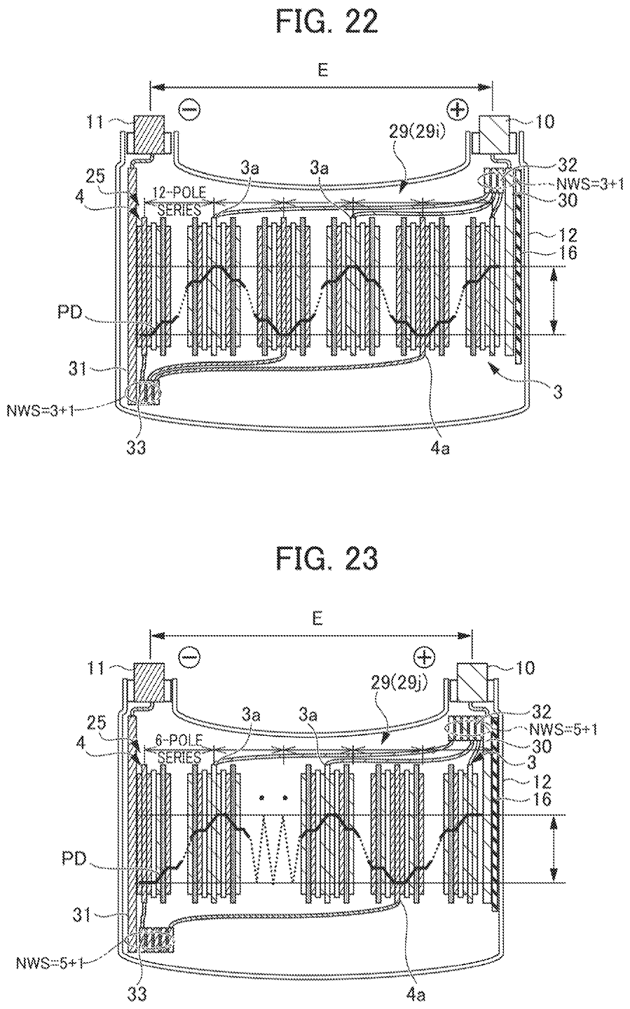

FIG. 22 is a configuration which connects in parallel five of the laminate bodies of twelve layers made by laminating twelve single laminate bodies 25 in series, and can be seen as being the composite parallel connection body 29 (29i) made by connecting five groups in parallel of twelve-pole series. In the case of FIG. 22, the positive electrode collector electrode plate 30 and the negative electrode collector electrode plate 31 are arranged at both ends in the lamination direction of the single laminate body 25. The conductors on the positive electrode side for connecting in parallel the laminate body of five layers are brought together at the positive electrode concentration connection part 32 and welded to the positive electrode collector electrode plate 30. In addition, the conductors on the negative electrode side for connecting in parallel the laminate body of five layers are brought together at the negative electrode concentration connection part 33 and welded to the negative electrode collector electrode plate 31. The composite parallel connection body 29i is accommodated in the outer packaging 12 which is a laminate. An outer packaging inner surface insulation sheet 16 is arranged between the positive electrode collector electrode plate 30 and the outer packaging 12. However, an intermediate insulation sheet is not arranged between the positive electrode collector electrode plate 30 and the positive electrode normal electrode 3 closest thereto. In the case of this embodiment, no potential difference arises between the positive electrode collector electrode plate 30 and the positive electrode normal electrode 3 closest thereto, and between the negative electrode collector electrode plate 31 and the negative electrode normal electrode 4 closest thereto. For this reason, insulation is unnecessary between the positive electrode collector electrode plate 30 and the positive electrode normal electrode 3 closest thereto, and between the negative electrode collector electrode plate 31 and the negative electrode normal electrode 4 closest thereto.

The occurrence status of the potential difference corresponding to the lamination layer of the single laminate bodies 25 within the composite parallel connection body 29i is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the twelve-pole series of FIG. 22 being a five-group parallel connection, NWS is 3+1 at the positive electrode tab 10, and NWS is 3+1 also at the negative electrode tab 11. The output electromotive force E is obtained between the positive electrode tab 10 and negative electrode tab 11.

FIG. 23 is a configuration which connects in parallel nine of the laminate bodies of six layers made by laminating six single laminate bodies 25 in series, and can be seen as being the composite parallel connection body 29 (29j) made by connecting nine groups in parallel of six-pole series. In the case of FIG. 23, the positive electrode collector electrode plate 30 and the negative electrode collector electrode plate 31 are arranged at both ends in the lamination direction of the single laminate body 25. The conductors on the positive electrode side for connecting in parallel the laminate body of six layers are brought together at the positive electrode concentration connection part 32 and welded to the positive electrode collector electrode plate 30. In addition, the conductors on the negative electrode side for connecting in parallel the laminate body of six layers are brought together at the negative electrode concentration connection part 33 and welded to the negative electrode collector electrode plate 31. The composite parallel connection body 29j is accommodated in the outer packaging 12 which is a laminate. An outer packaging inner surface insulation sheet 16 is arranged between the positive electrode collector electrode plate 30 and the outer packaging 12. However, an intermediate insulation sheet is not arranged between the positive electrode collector electrode plate 30 and the positive electrode normal electrode 3 closest thereto. In the case of this embodiment, no potential difference arises between the positive electrode collector electrode plate 30 and the positive electrode normal electrode 3 closest thereto, and between the negative electrode collector electrode plate 31 and the negative electrode normal electrode 4 closest thereto. For this reason, insulation is unnecessary between the positive electrode collector electrode plate 30 and the positive electrode normal electrode 3 closest thereto, and between the negative electrode collector electrode plate 31 and the negative electrode normal electrode 4 closest thereto.

The occurrence status of the potential difference corresponding to the lamination layer of the single laminate bodies 25 within the composite parallel connection body 29j is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the six-pole series of FIG. 23 being a nine-group parallel connection, NWS is 5+1 at the positive electrode tab 10, and NWS is 5+1 also at the negative electrode tab 11. The output electromotive force E is obtained between the positive electrode tab 10 and negative electrode tab 11.

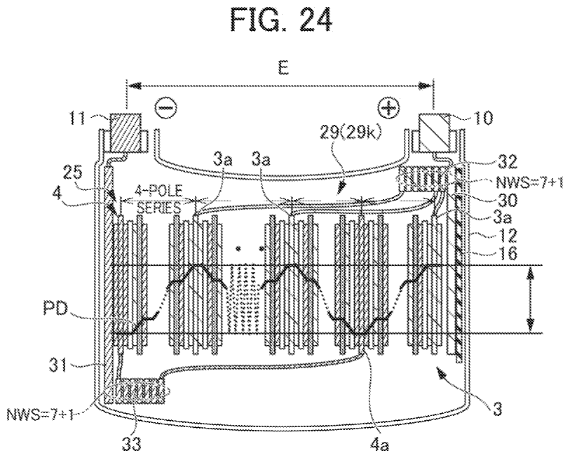

FIG. 24 is a configuration which connects in parallel thirteen of the laminate bodies of four layers made by laminating four single laminate bodies 25 in series, and can be seen as being the composite parallel connection body 29 (29k) made by connecting thirteen groups in parallel of four-pole series. In the case of FIG. 24, the positive electrode collector electrode plate 30 and the negative electrode collector electrode plate 31 are arranged at both ends in the lamination direction of the single laminate body 25. The conductors on the positive electrode side for connecting in parallel the laminate body of four layers are brought together at the positive electrode concentration connection part 32 and welded to the positive electrode collector electrode plate 30. In addition, the conductors on the negative electrode side for connecting in parallel the laminate body of four layers are brought together at the negative electrode concentration connection part 33 and welded to the negative electrode collector electrode plate 31. The composite parallel connection body 29k is accommodated in the outer packaging 12 which is a laminate. An outer packaging inner surface insulation sheet 16 is arranged between the positive electrode collector electrode plate 30 and the outer packaging 12. However, an intermediate insulation sheet is not arranged between the positive electrode collector electrode plate 30 and the positive electrode normal electrode 3 closest thereto. In the case of this embodiment, no potential difference arises between the positive electrode collector electrode plate 30 and the positive electrode normal electrode 3 closest thereto, and between the negative electrode collector electrode plate 31 and the negative electrode normal electrode 4 closest thereto. For this reason, insulation is unnecessary between the positive electrode collector electrode plate 30 and the positive electrode normal electrode 3 closest thereto, and between the negative electrode collector electrode plate 31 and the negative electrode normal electrode 4 closest thereto.

The occurrence status of the potential difference corresponding to the lamination layer of the single laminate bodies 25 within the composite parallel connection body 29k is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the four-pole series of FIG. 24 being a thirteen-group parallel connection, NWS is 7+1 at the positive electrode tab 10, and NWS is 7+1 also at the negative electrode tab 11. The output electromotive force E is obtained between the positive electrode tab 10 and negative electrode tab 11.

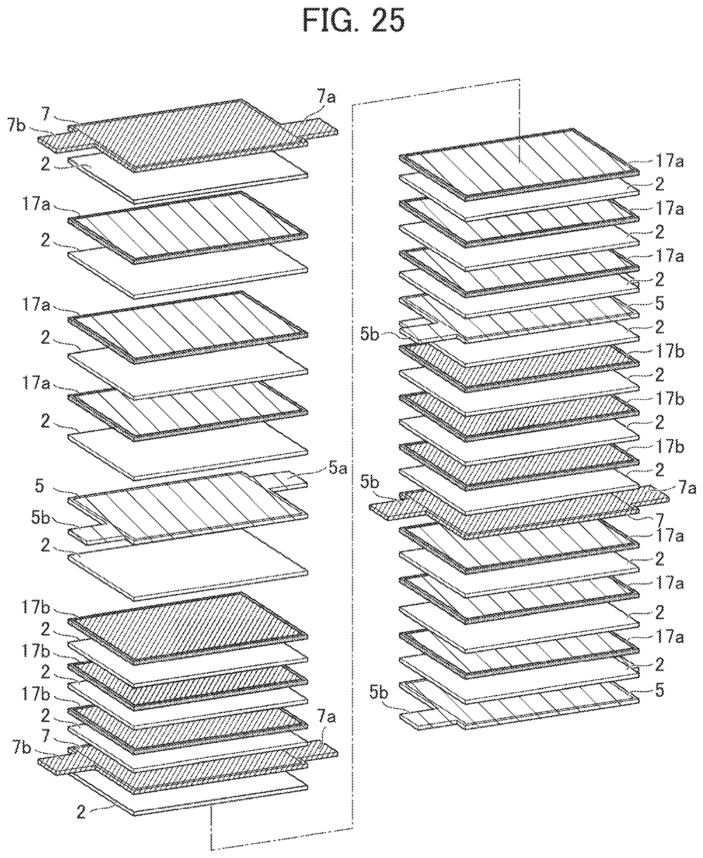

FIG. 25 is an exploded conceptual view for explaining the physical configuration of a laminate body of a plurality of layers made by arranging a plurality of single laminate bodies, a positive electrode collector electrode and negative electrode collector electrode, in the embodiment of the present invention. The configuration of FIG. 25 is a case of being a five-group parallel connection with the four-pole series. As illustrated, the negative electrode sheet-like collector 7 having the negative electrodes 7a, 7b is positioned at the topmost layer. The negative electrode sheet-like collector 7 is one form of the negative electrode normal electrode 4. The single laminate body (partial power generation element) composed of the solid electrolyte layer 2, bipolar electrode 17a of the first form and the solid electrolyte layer 2 is repeatedly laminated as in the illustration sequentially towards the bottom layer from the negative electrode sheet-like collector 7.

The bipolar electrode 17a of the first form is a bipolar electrode of a form in which the positive electrode material (positive electrode mixture slurry 19) is coated on the upper layer surface side in the lamination direction of the single laminate body of FIG. 25, and the negative electrode material (negative electrode mixture slurry 20) is coated on the lower layer surface side.

The positive electrode sheet-like collector 5 having the positive electrodes 5a, 5b is laminated at a place where repetition ends of lamination layers of single laminate body (partial power generation element) composed of the bipolar electrode 17a of the first form and the solid electrolyte layer 2. The positive electrode sheet-like collector 5 is one form of the positive electrode normal electrode 3. The single laminate (partial power generation element) composed by the bipolar electrode 17b of the second form and the solid electrolyte layer 2 are repeatedly laminated as in the illustrations, from the positive electrode sheet-like collector 5 further towards sequential lower layers.

The bipolar electrode 17b of the first form is a bipolar electrode of a form in which the negative electrode material (negative electrode mixture slurry 20) is coated on the upper layer surface side in the lamination direction of the single laminate body in FIG. 25, and the positive electrode material (positive electrode mixture slurry 19) is coated on the lower layer surface side.

The negative electrode sheet-like collector 7 having the negative electrode 7a, 7b is laminated at a place where repetition ends of lamination of the single laminate body (partial power generation element) composed of the bipolar electrode 17b of the second form and the solid electrolyte layer 2. Lamination is repeated as mentioned above from the negative electrode sheet-like collector 7 having the negative electrode 7a, 7b laminated again, further towards the sequential lower layers, as illustrated, and the positive electrode sheet-like collector 5 having the positive electrode 5a, 5b is laminated on the bottom most layer.

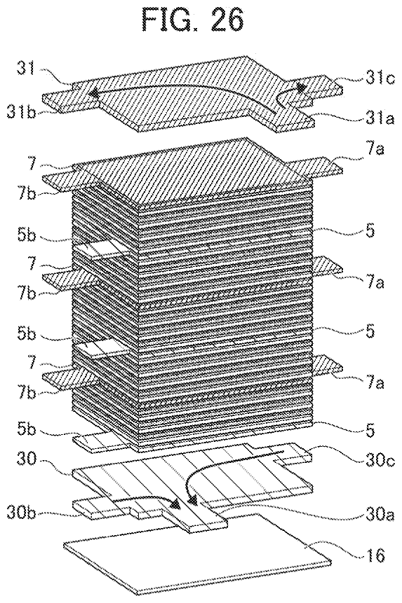

FIG. 26 is a conceptual diagram representing the form after lamination of the laminate body of FIG. 25. The negative electrode collector electrode plate 31 having the electrodes 31a, 31b, 31c is arranged on the negative electrode sheet-like collector 7, which is the topmost layer in the drawing of the laminate body of FIG. 25. In addition, the positive electrode collector electrode plate 30 having the electrodes 30a, 30b, 30c is arranged under the positive electrode sheet-like collector 5, which is the bottommost layer. The outer packaging inner surface insulation sheet 16 is arranged further below the positive electrode collector electrode plate 30. As illustrated, the positive electrodes 5a, 5b of each positive electrode sheet-like collector 5 overlaps at a projection position of the laminate body in the lamination direction. Similarly, the negative electrodes 7a, 7b of each negative electrode sheet-like collector 7 overlaps at the projection position of the laminate body in the lamination direction. It should be noted that, in the negative electrode collector electrode plate 31 and positive electrode collector electrode plate 30, the flow of electrical current within these collector electrode plates is conceptually depicted with arrows in the illustration.

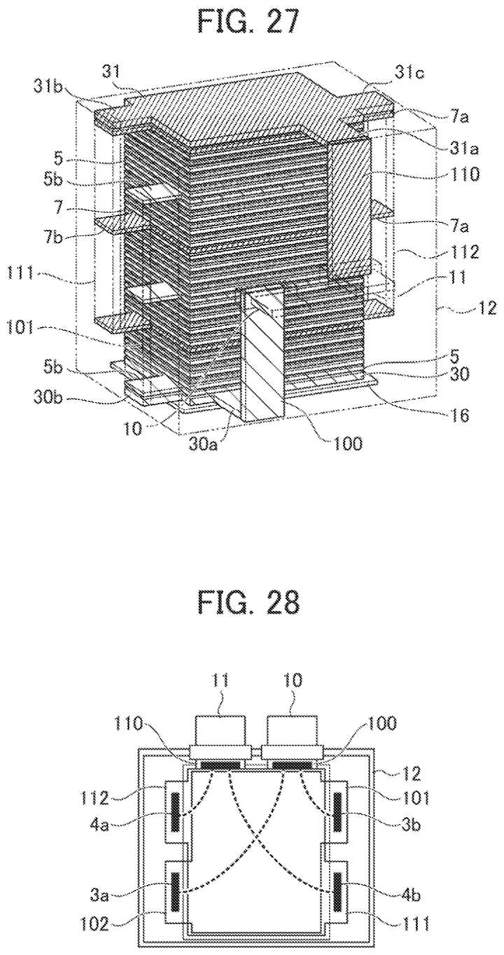

FIG. 27 is a view showing a battery pack made by storing the laminate body of FIG. 26 in the outer packaging. In the battery pack of FIG. 27, the positive electrodes 5b of each positive electrode sheet-like collector 5 which is at a position overlapping at the projection position of the laminate bodies in the lamination direction are connected in parallel by the positive electrode sub-connection conductor 101 which is the cell-internal collector conductor illustrated with virtual lines, then connected to the positive electrode collector electrode plate 30. The positive electrode collector electrode plate 30 is connected with the positive electrode tab 10 by the positive electrode main connection conductor 100. On the other hand, the negative electrodes 7b of each negative electrode sheet-like collectors 7 are connected in parallel by the negative electrode sub-connection conductor 111, which is a cell-internal collector conductor which is illustrated with virtual lines, and connected to the negative electrode collector electrode plate 31. The negative electrode collector electrode plate 31 is connected with the negative electrode tab 11 by the negative electrode main connection conductor 110.

The positive electrodes 5b of each positive electrode sheet-like collectors 5 are connected in parallel through the positive electrode sub-connection conductor 101, and connected so as to concentrate to the positive electrode main connection conductor 100, and guided to outside of the outer packaging 12 from the positive electrode tab 10. The positive electrodes 5a of each positive electrode sheet-like collectors 5, similarly, are connected in parallel through the positive electrode sub-connection conductor 102 (in FIG. 28), and connected so as to concentrate to the positive electrode main connection conductor 100, and is guided to outside of the outer packaging 12 from the positive electrode tab 10.

On the other hand, the negative electrodes 7b of each negative electrode sheet-like collectors 7 are connected in parallel through the negative electrode sub-connection conductor 111, and connected so as to concentrate at the negative electrode main connection conductor 110, and is guided to outside of the outer packaging 12 from the negative electrode tab 11. The negative electrodes 7a of each negative electrode sheet-like collector 7, similarly, are connected in parallel through the negative electrode sub-connection conductor 112, and connected so as to concentrate at the negative electrode main connection conductor 110, and guided to outside of the outer packaging 12 from the negative electrode tab 11.

FIG. 28 is a projection drawing of the laminate of the battery pack of FIG. 27 in a lamination direction. As illustrated, the positive electrode tab 10 and negative electrode tab 11 are led in parallel to outside from the same lateral surface of the rectangular outer packaging 12. The dotted lines in FIG. 28 conceptually represent the flow of electrical current from the positive electrode sub-connection conductors 101, 102 to the positive electrode tab 10, and the flow of electrical current from the negative electrode sub-connection conductors 111, 112 to the negative electrode tab 11. As illustrated, the electrical current flow paths related to the arrangement of conductors in the case of guiding the output to outside from the composite parallel connection body are differentiated for both positive and negative electrodes, and differentiation of the internal resistance value can be measured.

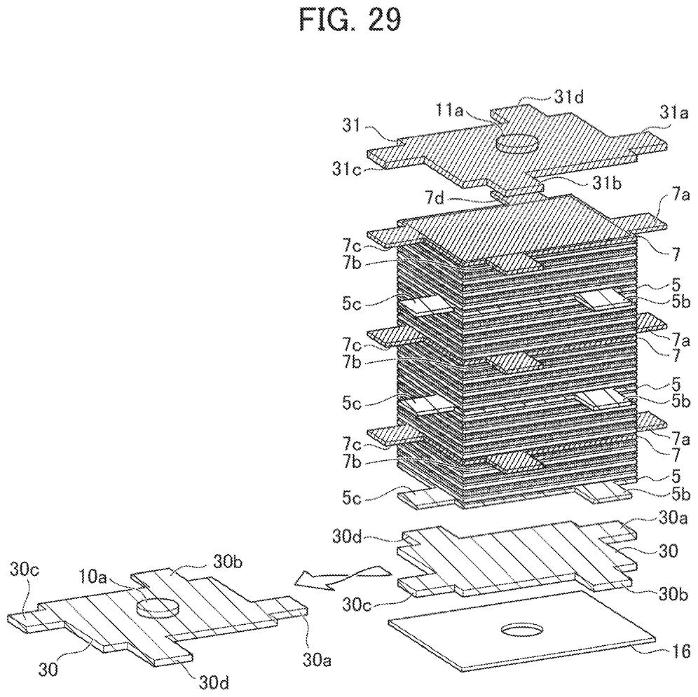

FIG. 29 is an exploded conceptual view for explaining the physical configuration of a laminate body of a plurality of layers made by laminating a plurality of single laminate bodies, further arranging the positive electrode collector electrode and negative electrode collector electrode, and arranging external connector terminals at both end parts in the lamination direction. The configuration of FIG. 29 is a case of being a five-group parallel connection with the four-pole series. As illustrated, the disk-shaped negative electrode terminal 11a is formed at a central part, and the negative electrode collector electrode plate 31 in which the electrodes 31a, 31b, 31c, 31d are formed to project laterally is position at the topmost layer. The negative electrode sheet-like collector 7 is arranged directly under the negative electrode collector electrode plate 31. The negative electrode sheet-like collector 7 is one form of the negative electrode normal electrode 4. The single laminate body is formed similarly as explained referencing FIG. 25, sequentially towards the bottom layer from the negative electrode sheet-like collector 7. For this reason, in FIG. 29, the corresponding parts with FIG. 25 are shown by assigning the same reference symbol, and the explanation of these corresponding parts is invoked. It should be noted that the differences of FIG. 29 from FIG. 25 are the point of the aforementioned negative electrode collector electrode plate 31 of the topmost layer and the positive electrode collector electrode plate 30 of the bottommost layer relative thereto being arranged, and the point of each negative electrode sheet-like collector 7 and positive electrode sheet-like collector 5 having four electrodes at the circumference. The reference symbols with a to d at the end are assigned to each of these four electrodes.

In the positive electrode collector electrode plate 30 of the bottommost layer, the disk-shaped positive electrode terminal 10a is formed at a central part, and electrodes 30a, 30b, 30c, 30d are formed so as to project laterally. It should be noted that, after assembly, the disk-shaped positive electrode terminal 10a faces downwards, and fits into an opening formed at the center of the outer packaging inner surface insulation sheet 16. The respective negative electrodes 7a, 7b, 7c, 7d of each negative electrode sheet-like collector 7 overlap at the projection position in the lamination direction of the laminate bodies. Similarly, the respective positive electrodes 5a, 5b, 5c, 5d of each positive electrode sheet-like collector 5 overlap at the projection position in the lamination direction of the laminate bodies.

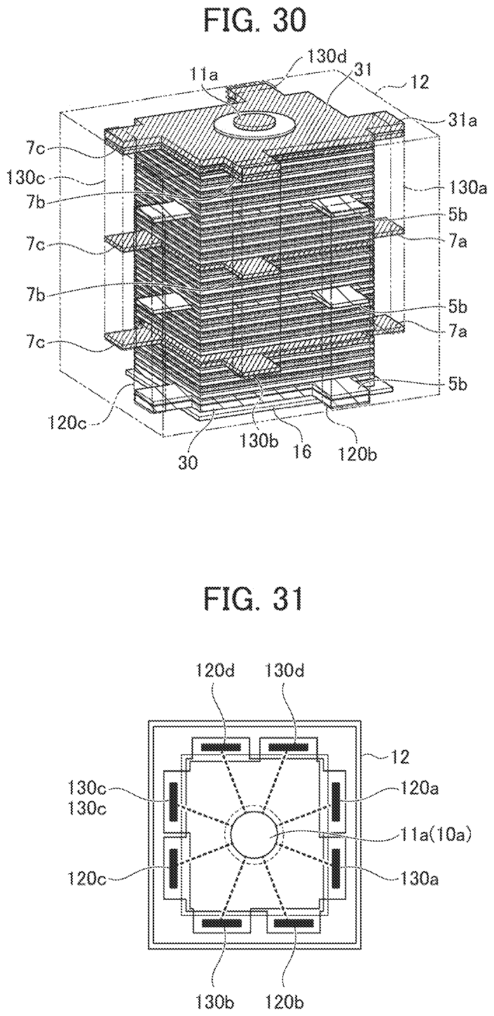

FIG. 30 is a view showing a battery pack storing the laminate body of FIG. 29 in an outer packaging. In the battery pack of FIG. 30, every negative electrode 7a, 7b, 7c, 7d of the respective negative electrode sheet-like collectors 7 is connected in parallel by the negative electrode sub-connection conductors 130a, 130b, 130c, 130d, which are cell internal collector conductors illustrated by virtual lines. Each negative electrode sub-connection conductor 130a, 130b, 130c, 130d is connected to the negative electrode main collector plate 130, which is arranged so as to further cover over the negative electrode collector electrode plate 31 which is the topmost layer, relatively. The disk-shaped negative electrode terminal 11a of the negative electrode collector electrode plate 31 is exposed to outside from an opening in the center of the negative electrode main collector plate 130. On the other hand, every positive electrode 5a, 5b, 5c, 5d of each positive electrode sheet-like collector 5 is respectively connected in parallel by the positive electrode sub-connection conductors 120a, 120b, 120c, 120d, which are cell internal collector conductors illustrated by virtual lines. Each positive electrode sub-connection conductor 120a, 120b, 120c, 120d is connected to the positive electrode collector electrode plate 30 arranged at the bottommost layer. The disk-shaped positive electrode terminal 10a of the positive electrode collector electrode plate 30 is exposed downwards to outside from an opening formed at the center of the outer packaging inner surface insulation sheet 16.

FIG. 31 is a projection drawing of the laminate of the battery pack of FIG. 30 in a lamination direction. As illustrated, the disk-shaped negative electrode terminal 11a of the negative electrode collector electrode plate 31 and the disk-shaped positive electrode terminal 10a of the positive electrode collector electrode plate 30 are positioned so as to overlap at substantially the center of the rectangular outer packaging 12 in the projection in the lamination direction of the laminate body. The dotted lines in FIG. 31 conceptually represent the flow of electrical current between each negative electrode sub-connection conductor 130a, 130b, 130c, 130d and the negative electrode terminal 11a, and the flow of electrical current between each positive electrode sub-connection conductor 120a, 120b, 120c, 120d and the positive electrode terminal 10a. As illustrated, the electrical current flow paths related to the arrangement of conductors in the case of guiding the output to outside from the composite parallel connection body are differentiated for both positive and negative electrodes, and differentiation of the internal resistance value can be measured.

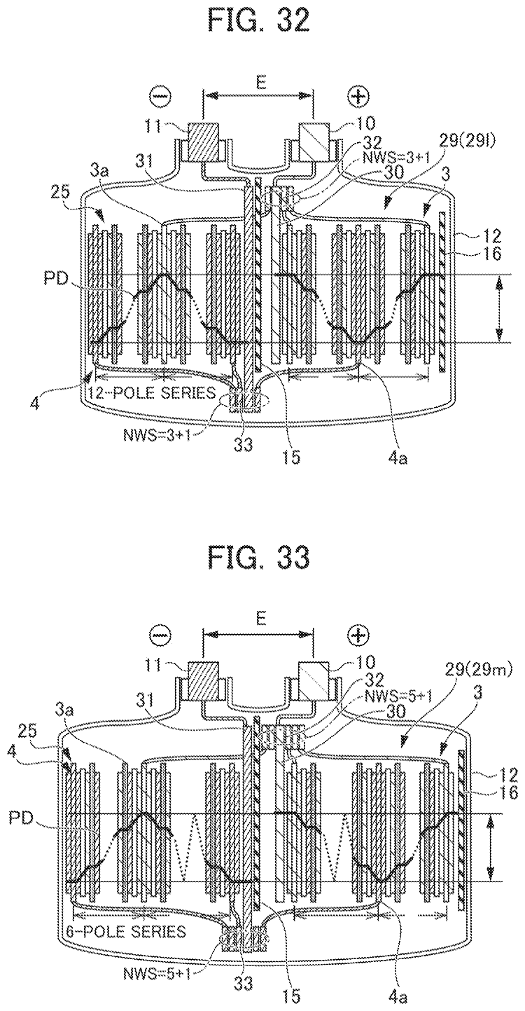

FIG. 32 is a configuration which connects in parallel four of the laminate bodies of twelve layers made by laminating twelve single laminate bodies 25 in series, and can be seen as being the composite parallel connection body 29 (291) made by connecting four groups in parallel of twelve-pole series. In the case of FIG. 32, the positive electrode collector electrode plate 30 and the negative electrode collector electrode plate 31 are arranged in parallel at the central part between both ends in the lamination direction of the single laminate body 25. The conductors on the positive electrode side for connecting in parallel the laminate body of twelve layers are brought together at the positive electrode concentration connection part 32 and welded to the positive electrode collector electrode plate 30. In addition, the conductors on the negative electrode side for connecting in parallel the laminate body of twelve layers are brought together at the negative electrode concentration connection part 33 and welded to the negative electrode collector electrode plate 31. The composite parallel connection body 291 is accommodated in the outer packaging 12 which is a laminate. The outer packaging inner surface insulation sheet 16 is arranged between the positive electrode normal electrode 3 on one end side in the lamination direction of the single laminate body 25 and the outer packaging 12. In addition, an intermediate insulation sheet 15 is arranged between the positive electrode collector electrode plate 30 and the negative electrode collector electrode plate 31. In the case of this embodiment, no potential difference arises between the positive electrode collector electrode plate 30 and the positive electrode normal electrode 3 closest thereto, and between the negative electrode collector electrode plate 31 and the negative electrode normal electrode 4 closest thereto. For this reason, insulation is unnecessary between the positive electrode collector electrode plate 30 and the positive electrode normal electrode 3 closest thereto, and between the negative electrode collector electrode plate 31 and the negative electrode normal electrode 4 closest thereto.

The occurrence status of the potential difference corresponding to the lamination layer of the single laminate bodies 25 within the composite parallel connection body 291 is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the twelve-pole series of FIG. 32 being a four-group parallel connection, NWS is 3+1 at the positive electrode tab 10, and NWS is 3+1 also at the negative electrode tab 11. The output electromotive force E is obtained between the positive electrode tab 10 and negative electrode tab 11.

FIG. 33 is a configuration which connects in parallel eight of the laminate bodies of six layers made by laminating six single laminate bodies 25 in series, and can be seen as being the composite parallel connection body 29 (29m) made by connecting eight groups in parallel of six-pole series. In the case of FIG. 33, the positive electrode collector electrode plate 30 and the negative electrode collector electrode plate 31 are arranged in parallel at the central part between both ends in the lamination direction of the single laminate body 25. The conductors on the positive electrode side for connecting in parallel the laminate body of six layers are brought together at the positive electrode concentration connection part 32 and welded to the positive electrode collector electrode plate 30. In addition, the conductors on the negative electrode side for connecting in parallel the laminate body of six layers are brought together at the negative electrode concentration connection part 33 and welded to the negative electrode collector electrode plate 31. The composite parallel connection body 29m is accommodated in the outer packaging 12 which is a laminate. The outer packaging inner surface insulation sheet 16 is arranged between the positive electrode normal electrode 3 on one end side in the lamination direction of the single laminate body 25 and the outer packaging 12. In addition, an intermediate insulation sheet 15 is arranged between the positive electrode collector electrode plate 30 and the negative electrode collector electrode plate 31. In the case of this embodiment, no potential difference arises between the positive electrode collector electrode plate 30 and the positive electrode normal electrode 3 closest thereto, and between the negative electrode collector electrode plate 31 and the negative electrode normal electrode 4 closest thereto. For this reason, insulation is unnecessary between the positive electrode collector electrode plate 30 and the positive electrode normal electrode 3 closest thereto, and between the negative electrode collector electrode plate 31 and the negative electrode normal electrode 4 closest thereto.

The occurrence status of the potential difference corresponding to the lamination layer of the single laminate bodies 25 within the composite parallel connection body 29m is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the six-pole series of FIG. 33 being an eight-group parallel connection, NWS is 5+1 at the positive electrode tab 10, and NWS is 5+1 also at the negative electrode tab 11. The output electromotive force E is obtained between the positive electrode tab 10 and negative electrode tab 11.

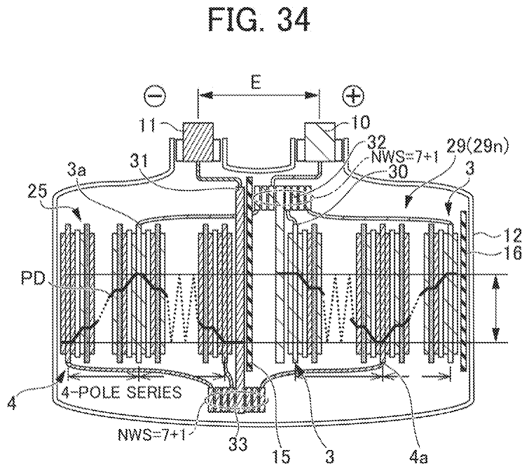

FIG. 34 is a configuration which connects in parallel twelve of the laminate bodies of four layers made by laminating four single laminate bodies 25 in series, and can be seen as being the composite parallel connection body 29 (29n) made by connecting twelve groups in parallel of four-pole series. In the case of FIG. 34, the positive electrode collector electrode plate 30 and the negative electrode collector electrode plate 31 are arranged in parallel at the central part between both ends in the lamination direction of the single laminate body 25. The conductors on the positive electrode side for connecting in parallel the laminate body of four layers are brought together at the positive electrode concentration connection part 32 and welded to the positive electrode collector electrode plate 30. In addition, the conductors on the negative electrode side for connecting in parallel the laminate body of four layers are brought together at the negative electrode concentration connection part 33 and welded to the negative electrode collector electrode plate 31. The composite parallel connection body 29n is accommodated in the outer packaging 12 which is a laminate. The outer packaging inner surface insulation sheet 16 is arranged between the positive electrode normal electrode 3 on one end side in the lamination direction of the single laminate body 25 and the outer packaging 12. In addition, an intermediate insulation sheet 15 is arranged between the positive electrode collector electrode plate 30 and the negative electrode collector electrode plate 31. In the case of this embodiment, no potential difference arises between the positive electrode collector electrode plate 30 and the positive electrode normal electrode 3 closest thereto, and between the negative electrode collector electrode plate 31 and the negative electrode normal electrode 4 closest thereto. For this reason, insulation is unnecessary between the positive electrode collector electrode plate 30 and the positive electrode normal electrode 3 closest thereto, and between the negative electrode collector electrode plate 31 and the negative electrode normal electrode 4 closest thereto.

The occurrence status of the potential difference corresponding to the lamination layer of the single laminate bodies 25 within the composite parallel connection body 29n is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the four-pole series of FIG. 34 being an twelve-group parallel connection, NWS is 7+1 at the positive electrode tab 10, and NWS is 7+1 also at the negative electrode tab 11. The output electromotive force E is obtained between the positive electrode tab 10 and negative electrode tab 11.

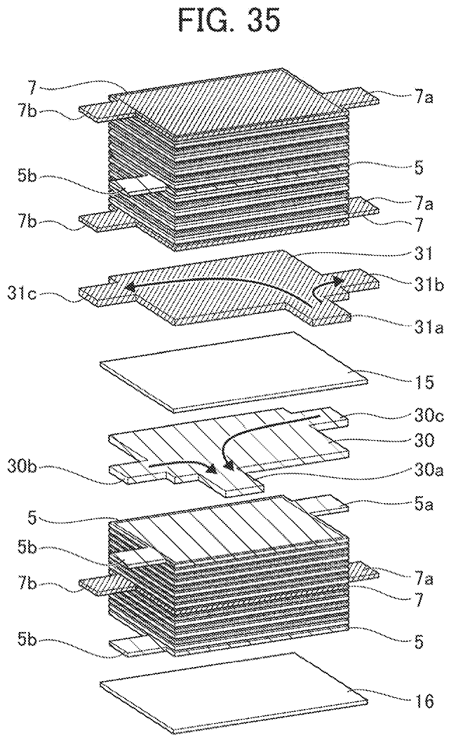

FIG. 35 is an exploded conceptual view for explaining the physical configuration of a laminate body of a plurality of layers made by laminating a plurality of single laminate bodies, further arranging the positive electrode collector electrode and negative electrode collector electrode, and arranging an insulation sheet. The configuration of FIG. 35 is a case of being a four-group parallel connection with the four-pole series. As illustrated, the negative electrode sheet-like collector 7 having the negative electrodes 7a, 7b is positioned at the topmost layer. The negative electrode sheet-like collector 7 is one form of the negative electrode normal electrode 4. The single laminate body is formed similarly as explained referencing FIGS. 25 and 26, sequentially towards the bottom layer from the negative electrode sheet-like collector 7. For this reason, in FIG. 35, the corresponding parts with FIGS. 25 and 26 are shown by assigning the same reference symbol, and the explanation of these corresponding parts is invoked. It should be noted that the difference of FIG. 35 from FIGS. 25 and 26 is the point in that the negative electrode collector electrode plate and positive electrode collector electrode plate 30 are not in the uppermost layer and the lowermost layer but in an intermediate portion in the lamination direction. In other words, the negative electrode collector electrode plate 31 and positive electrode collector electrode plate 30 are arranged at an intermediate site in the lamination direction, in parallel to sandwich the intermediate insulation sheet 15. It should be noted that, in the negative electrode collector electrode plate 31 and positive electrode collector electrode plate 30, the flow of electrical current within these collector electrode plates is conceptually depicted with arrows in the illustration.

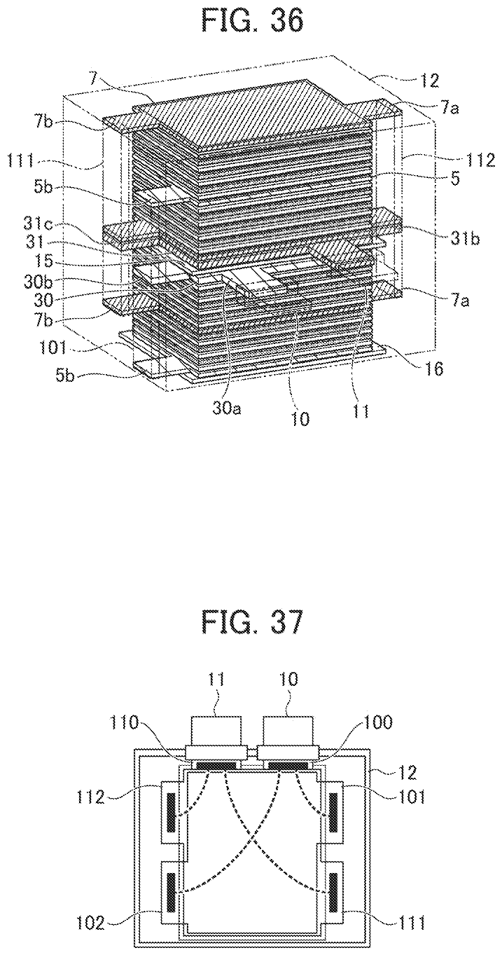

FIG. 36 is a view showing a battery pack made by storing the laminate body of FIG. 35 in the outer packaging. In the battery pack of FIG. 36, the positive electrodes 5b of each positive electrode sheet-like collector 5 which is at a position overlapping at the projection position of the laminate bodies in the lamination direction are connected in parallel by the positive electrode sub-connection conductor 101 which is the cell-internal collector conductor illustrated with virtual lines, then connected to the positive electrode collector electrode plate 30. The positive electrode collector electrode plate 30 is connected with the positive electrode tab 10 by a part of itself. On the other hand, the negative electrodes 7b of each negative electrode sheet-like collectors 7 are connected in parallel by the negative electrode sub-connection conductor 111, which is a cell-internal collector conductor which is illustrated with virtual lines, and connected to the negative electrode collector electrode plate 31. The negative electrode collector electrode plate 31 forms a negative electrode tab 11 by an extension part of the electrode 31a.

The positive electrodes 5b of each positive electrode sheet-like collector 5 are connected in parallel through the positive electrode sub-connection conductor 101, and connected so as to concentrate to the positive electrode collector electrode plate 30, and guided to outside of the outer packaging 12 from the positive electrode tab 10. The positive electrodes 5a of each positive electrode sheet-like collector 5, similarly, are connected in parallel through the positive electrode sub-connection conductor 102, and connected so as to concentrate to the positive electrode collector electrode plate 30, and is guided to outside of the outer packaging 12 from the positive electrode tab 10 formed at the extension part of the electrode 30a.

On the other hand, the negative electrodes 7b of each negative electrode sheet-like collector 7 are connected in parallel through the negative electrode sub-connection conductor 111, and connected so as to concentrate at the negative electrode collector electrode plate 31, and is guided to outside of the outer packaging 12 from the negative electrode tab 11. The negative electrodes 7a of each negative electrode sheet-like collector 7, similarly, are connected in parallel through the negative electrode sub-connection conductor 112, and connected so as to concentrate at the negative electrode collector electrode plate 31, and guided to outside of the outer packaging 12 from the negative electrode tab 11.

FIG. 37 is a projection view in the lamination direction of laminate bodies of the battery pack in FIG. 36. As illustrated, the positive electrode tab 10 and negative electrode tab 11 are led in parallel to outside from the same lateral surface of the rectangular outer packaging 12. The dotted lines in FIG. 37 conceptually represent the flow of electrical current from the positive electrode sub-connection conductors 101, 102 to the positive electrode tab 10, and the flow of electrical current from the negative electrode sub-connection conductors 111, 112 to the negative electrode tab 11. As illustrated, the electrical current flow paths related to the arrangement of conductors in the case of guiding the output to outside from the composite parallel connection body are differentiated for both positive and negative electrodes, and differentiation of the internal resistance value can be measured.

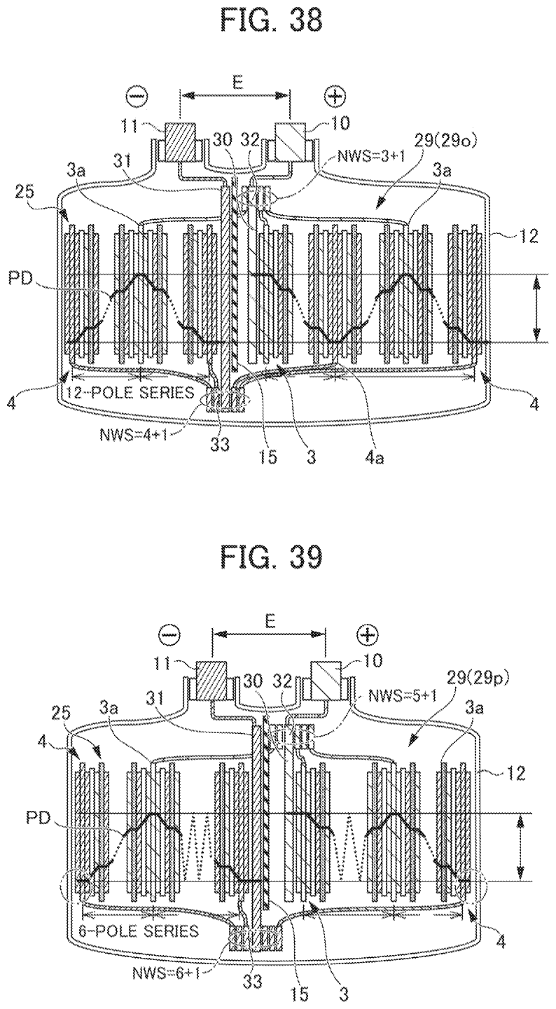

FIG. 38 is a configuration which connects in parallel five of the laminate bodies of twelve layers made by laminating twelve single laminate bodies 25 in series, and can be seen as being the composite parallel connection body 29 (29o) made by connecting five groups in parallel of twelve-pole series. In the case of FIG. 38, the positive electrode collector electrode plate 30 and the negative electrode collector electrode plate 31 are arranged in parallel at the central part between both ends in the lamination direction of the single laminate body 25. The conductors on the positive electrode side for connecting in parallel the laminate body of twelve layers are brought together at the positive electrode concentration connection part 32 and welded to the positive electrode collector electrode plate 30. In addition, the conductors on the negative electrode side for connecting in parallel the laminate body of twelve layers are brought together at the negative electrode concentration connection part 33 and welded to the negative electrode collector electrode plate 31. The composite parallel connection body 290 is accommodated in the outer packaging 12 which is a laminate. An intermediate insulation sheet 15 is arranged between the positive electrode collector electrode plate 30 and the negative electrode collector electrode plate 31. In the case of this embodiment, no potential difference arises between the positive electrode collector electrode plate 30 and the positive electrode normal electrode 3 closest thereto, and between the negative electrode collector electrode plate 31 and the negative electrode normal electrode 4 closest thereto. For this reason, insulation is unnecessary between the positive electrode collector electrode plate 30 and the positive electrode normal electrode 3 closest thereto, and between the negative electrode collector electrode plate 31 and the negative electrode normal electrode 4 closest thereto. In addition, by the normal electrode on both outermost end sides of the single laminate body 25 both being the negative electrode normal electrode 4, since a potential difference will not arise between contact surfaces with the outer packaging 12, an insulation sheet is not arranged between these.

The occurrence status of the potential difference corresponding to the lamination layer of the single laminate bodies 25 within the composite parallel connection body 290 is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the twelve-pole series of FIG. 38 being an five-group parallel connection, NWS is 3+1 at the positive electrode tab 10, and NWS is 4+1 also at the negative electrode tab 11. The output electromotive force E is obtained between the positive electrode tab 10 and negative electrode tab 11.

FIG. 39 is a configuration which connects in parallel nine of the laminate bodies of six layers made by laminating six single laminate bodies 25 in series, and can be seen as being the composite parallel connection body 29 (29p) made by connecting nine groups in parallel of six-pole series. In the case of FIG. 39, the positive electrode collector electrode plate 30 and the negative electrode collector electrode plate 31 are arranged in parallel at the central part between both ends in the lamination direction of the single laminate body 25. The conductors on the positive electrode side for connecting in parallel the laminate body of six layers are brought together at the positive electrode concentration connection part 32 and welded to the positive electrode collector electrode plate 30. In addition, the conductors on the negative electrode side for connecting in parallel the laminate body of six layers are brought together at the negative electrode concentration connection part 33 and welded to the negative electrode collector electrode plate 31. The composite parallel connection body 29p is accommodated in the outer packaging 12 which is a laminate. An intermediate insulation sheet 15 is arranged between the positive electrode collector electrode plate 30 and the negative electrode collector electrode plate 31. In the case of this embodiment, no potential difference arises between the positive electrode collector electrode plate 30 and the positive electrode normal electrode 3 closest thereto, and between the negative electrode collector electrode plate 31 and the negative electrode normal electrode 4 closest thereto. For this reason, insulation is unnecessary between the positive electrode collector electrode plate 30 and the positive electrode normal electrode 3 closest thereto, and between the negative electrode collector electrode plate 31 and the negative electrode normal electrode 4 closest thereto. In addition, by the normal electrode on both outermost end sides of the single laminate body 25 both being the negative electrode normal electrode 4, since a potential difference will not arise between contact surfaces with the outer packaging 12, an insulation sheet is not arranged between these.

The occurrence status of the potential difference corresponding to the lamination layer of the single laminate bodies 25 within the composite parallel connection body 29p is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the six-pole series of FIG. 39 being an nine-group parallel connection, NWS is 5+1 at the positive electrode tab 10, and NWS is 6+1 also at the negative electrode tab 11. The output electromotive force E is obtained between the positive electrode tab 10 and negative electrode tab 11.

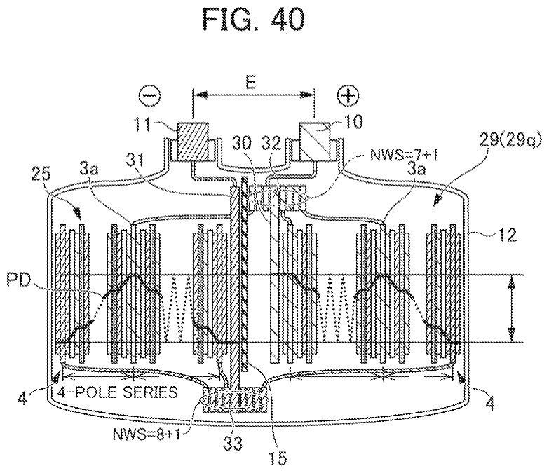

FIG. 40 is a configuration which connects in parallel thirteen of the laminate bodies of four layers made by laminating four single laminate bodies 25 in series, and can be seen as being the composite parallel connection body 29 (29q) made by connecting thirteen groups in parallel of four-pole series. In the case of FIG. 40, the positive electrode collector electrode plate 30 and the negative electrode collector electrode plate 31 are arranged in parallel at the central part between both ends in the lamination direction of the single laminate body 25. The conductors on the positive electrode side for connecting in parallel the laminate body of four layers are brought together at the positive electrode concentration connection part 32 and welded to the positive electrode collector electrode plate 30. In addition, the conductors on the negative electrode side for connecting in parallel the laminate body of four layers are brought together at the negative electrode concentration connection part 33 and welded to the negative electrode collector electrode plate 31. The composite parallel connection body 29q is accommodated in the outer packaging 12 which is a laminate. An intermediate insulation sheet 15 is arranged between the positive electrode collector electrode plate 30 and the negative electrode collector electrode plate 31. In the case of this embodiment, no potential difference arises between the positive electrode collector electrode plate 30 and the positive electrode normal electrode 3 closest thereto, and between the negative electrode collector electrode plate 31 and the negative electrode normal electrode 4 closest thereto. For this reason, insulation is unnecessary between the positive electrode collector electrode plate 30 and the positive electrode normal electrode 3 closest thereto, and between the negative electrode collector electrode plate 31 and the negative electrode normal electrode 4 closest thereto. In addition, by the normal electrode on both outermost end sides of the single laminate body 25 both being the negative electrode normal electrode 4, since a potential difference will not arise between contact surfaces with the outer packaging 12, an insulation sheet is not arranged between these.

The occurrence status of the potential difference corresponding to the lamination layer of the single laminate bodies 25 within the composite parallel connection body 29q is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the four-pole series of FIG. 40 being an thirteen-group parallel connection, NWS is 7+1 at the positive electrode tab 10, and NWS is 8+1 also at the negative electrode tab 11. The output electromotive force E is obtained between the positive electrode tab 10 and negative electrode tab 11.

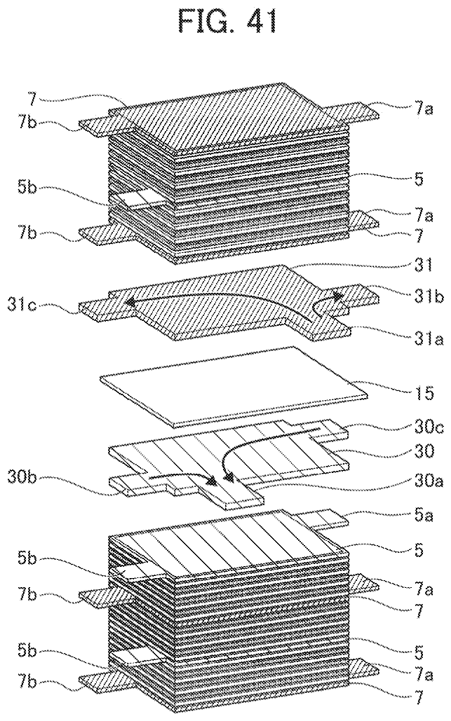

FIG. 41 is an exploded conceptual view for explaining the physical configuration of another configurational example of a laminate body of a plurality of layers made by laminating a plurality of single laminate bodies, further arranging a positive electrode collector electrode and negative electrode collector electrode, and arranging an insulation sheet. The configuration of FIG. 41 is a case of being a five-group parallel connection with the four-pole series. As illustrated, the negative electrode sheet-like collector 7 having the negative electrodes 7a, 7b is positioned at the topmost layer. The negative electrode sheet-like collector 7 is one form of the negative electrode normal electrode 4. The single laminate body is formed similarly as explained referencing FIGS. 25 and 26, sequentially towards the bottom layer from the negative electrode sheet-like collector 7. For this reason, in FIG. 41, the corresponding parts with FIGS. 25 and 26 are shown by assigning the same reference symbol, and the explanation of these corresponding parts is invoked. It should be noted that the difference of FIG. 41 from FIG. 35 which was explained by invoking FIGS. 25 and 26 is the point of there not being an insulation sheet (outer packaging inner surface insulation sheet 16) as the bottommost layer. It should be noted that, in the negative electrode collector electrode plate 31 and positive electrode collector electrode plate 30, the flow of electrical current within these collector electrode plates is conceptually depicted with arrows in the illustration.

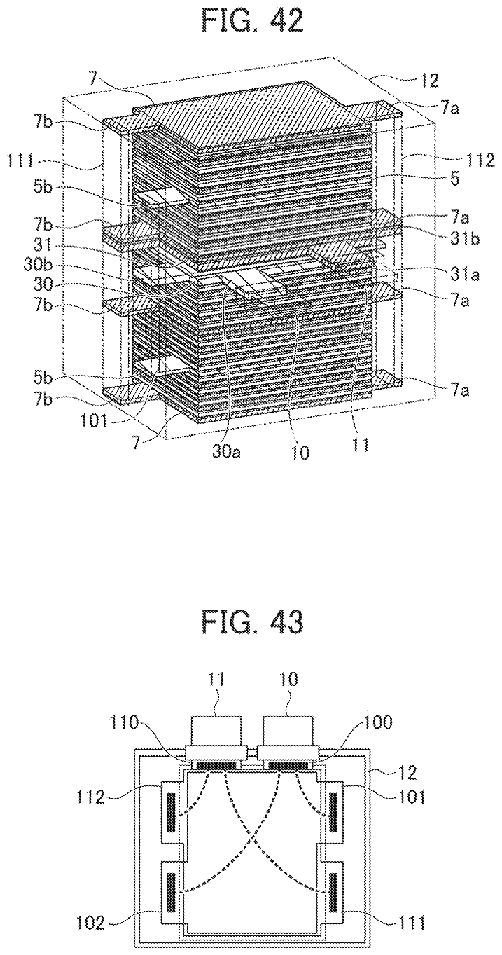

FIG. 42 is a view showing a battery pack made by storing the laminate body of FIG. 41 in the outer packaging. In the battery pack of FIG. 42, the positive electrodes 5b of each positive electrode sheet-like collector 5 which is at a position overlapping at the projection position of the laminate bodies in the lamination direction are connected in parallel by the positive electrode sub-connection conductor 101 which is the cell-internal collector conductor illustrated with virtual lines, then connected to the positive electrode collector electrode plate 30. The positive electrode collector electrode plate 30 is connected with the positive electrode tab 10 by a part of itself. On the other hand, the negative electrodes 7b of each negative electrode sheet-like collector 7 are connected in parallel by the negative electrode sub-connection conductor 111, which is a cell-internal collector conductor which is illustrated with virtual lines, and connected to the negative electrode collector electrode plate 31. The negative electrode collector electrode plate 31 forms a negative electrode tab 11 by an extension part thereof. The positive electrodes 5b of each positive electrode sheet-like collector 5 are connected in parallel through the positive electrode sub-connection conductor 101, and connected so as to concentrate to the positive electrode collector electrode plate 30, and guided to outside of the outer packaging 12 from the positive electrode tab 10. The positive electrodes 5a of each positive electrode sheet-like collector 5, similarly, are connected in parallel through the positive electrode sub-connection conductor 102 (in FIG. 43), and connected so as to concentrate to the positive electrode collector electrode plate 30, and is guided to outside of the outer packaging 12 from the positive electrode tab 10 formed at the extension part of the electrode 30a.

On the other hand, the negative electrodes 7b of each negative electrode sheet-like collector 7 are connected in parallel through the negative electrode sub-connection conductor 111, and connected so as to concentrate at the negative electrode collector electrode plate 31, and is guided to outside of the outer packaging 12 from the negative electrode tab 11. The negative electrodes 7a of each negative electrode sheet-like collector 7, similarly, are connected in parallel through the negative electrode sub-connection conductor 112, and connected so as to concentrate at the negative electrode collector electrode plate 31, and guided to outside of the outer packaging 12 from the negative electrode tab 11.

FIG. 43 is a projection view in the lamination direction of laminate bodies of the battery pack in FIG. 42. As illustrated, the positive electrode tab 10 and negative electrode tab 11 are led in parallel to outside from the same lateral surface of the rectangular outer packaging 12. The dotted lines in FIG. 37 conceptually represent the flow of electrical current from the positive electrode sub-connection conductors 101, 102 to the positive electrode tab 10, and the flow of electrical current from the negative electrode sub-connection conductors 111, 112 to the negative electrode tab 11. As illustrated, the electrical current flow paths related to the arrangement of conductors in the case of guiding the output to outside from the composite parallel connection body are differentiated for both positive and negative electrodes, and differentiation of the internal resistance value can be measured.

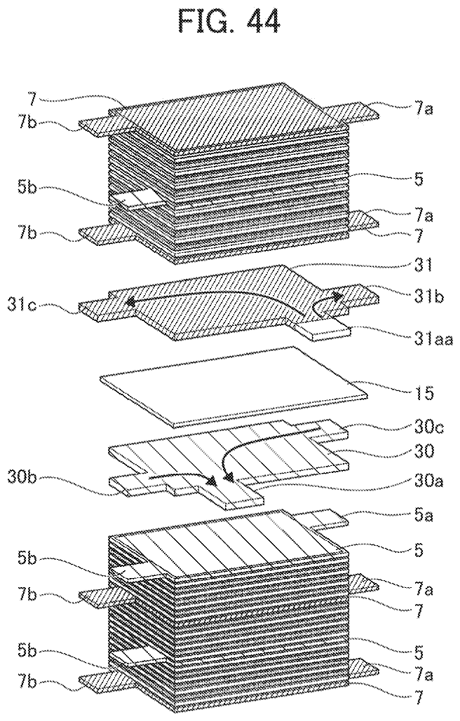

FIG. 44 is an exploded conceptual view for explaining the physical configuration of another configurational example of a laminate body of a plurality of layers made by laminating a plurality of single laminate bodies, further arranging a positive electrode collector electrode and negative electrode collector electrode, and arranging an insulation sheet. Since the mode of the lamination of the laminate body in FIG. 44 is the same as the case of FIG. 41, the explanation of FIG. 41 will be invoked in entirety. The point of difference from the laminate body of FIG. 41 is the point of the material of the negative electrode 31aa of the negative electrode collector electrode plate 31 being the same material as the positive electrode collector electrode plate 30 at the leading end side thereof. The remaining points thereof are the same as the case of FIG. 41.

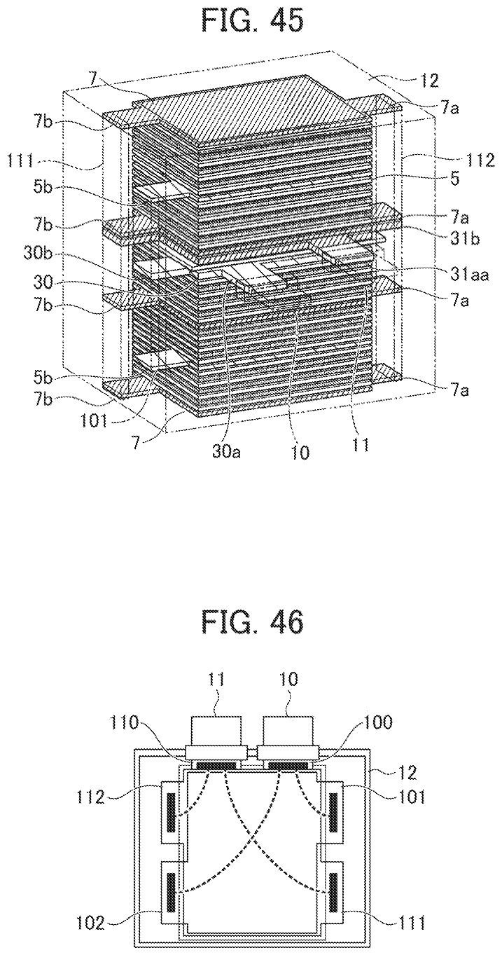

Also for FIG. 45 showing the battery pack made by storing the laminate body of FIG. 44 in the outer packaging, and FIG. 46 which is a projection drawing in the lamination direction of the laminate body of the battery pack of FIG. 45, the explanations of the previously mentioned FIGS. 42 and 43 will be invoked in entirety. It should be noted that, in the negative electrode collector electrode plate 31 and positive electrode collector electrode plate 30, the flow of electrical current within these collector electrode plates is conceptually depicted with arrows in the illustration.

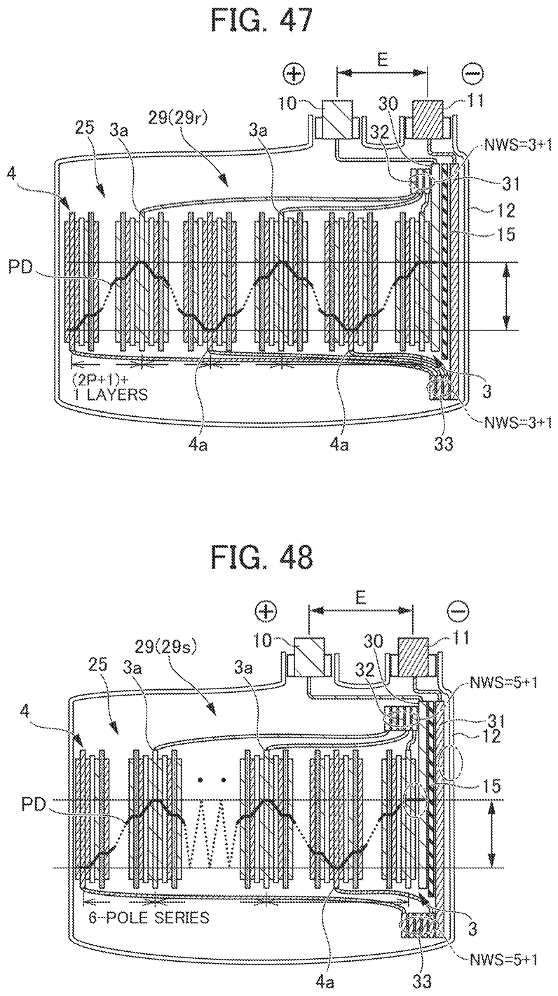

FIG. 47 is a configuration which connects in parallel five of the laminate bodies of twelve layers made by laminating twelve single laminate bodies 25 in series, and can be seen as being the composite parallel connection body 29 (29r) made by connecting five groups in parallel of twelve-pole series. In the case of FIG. 47, the positive electrode collector electrode plate 30 and the negative electrode collector electrode plate 31 are arranged in parallel at one end side among both ends in the lamination direction of the single laminate body 25. In this case, the negative electrode collector electrode plate 31 is arranged closer to the outer side than this one end. The conductors on the positive electrode side for connecting in parallel the laminate bodies of twelve layers are brought together at the positive electrode concentration connection part 32 and welded to the positive electrode collector electrode plate 30. In addition, the conductors on the negative electrode side for connecting in parallel the laminate body of twelve layers are brought together at the negative electrode concentration connection part 33 and welded to the negative electrode collector electrode plate 31. The composite parallel connection body 29r is accommodated in the outer packaging 12 which is a laminate. An intermediate insulation sheet 15 is arranged between the positive electrode collector electrode plate 30 and the negative electrode collector electrode plate 31. In the case of this embodiment, no potential difference arises between the positive electrode collector electrode plate 30 and the positive electrode normal electrode 3 closest thereto. For this reason, insulation is unnecessary between the positive electrode collector electrode plate 30 and the positive electrode normal electrode 3 closest thereto. In addition, since a potential difference will not arise between the negative electrode normal electrode 4 and the negative electrode collector electrode plate 31, an insulation sheet is not arranged between these and the outer packaging 12.

The occurrence status of the potential difference corresponding to the lamination layer of the single laminate bodies 25 within the composite parallel connection body 29r is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the twelve-pole series of FIG. 47 being a five-group parallel connection, NWS is 3+1 at the positive electrode tab 10, and NWS is 3+1 also at the negative electrode tab 11. The output electromotive force E is obtained between the positive electrode tab 10 and negative electrode tab 11.

FIG. 48 is a configuration which connects in parallel nine of the laminate bodies of six layers made by laminating six single laminate bodies 25 in series, and can be seen as being the composite parallel connection body 29 (29s) made by connecting nine groups in parallel of six-pole series. In the case of FIG. 48, the positive electrode collector electrode plate 30 and the negative electrode collector electrode plate 31 are arranged in parallel at one end side among between both ends in the lamination direction of the single laminate body 25. In this case, the negative electrode collector electrode plate 31 is arranged closer to the outer side than this one end. The conductors on the positive electrode side for connecting in parallel the laminate body of six layers are brought together at the positive electrode concentration connection part 32 and welded to the positive electrode collector electrode plate 30. In addition, the conductors on the negative electrode side for connecting in parallel the laminate body of six layers are brought together at the negative electrode concentration connection part 33 and welded to the negative electrode collector electrode plate 31. The composite parallel connection body 29s is accommodated in the outer packaging 12 which is a laminate. An intermediate insulation sheet 15 is arranged between the positive electrode collector electrode plate 30 and the negative electrode collector electrode plate 31. In the case of this embodiment, no potential difference arises between the positive electrode collector electrode plate 30 and the positive electrode normal electrode 3 closest thereto. For this reason, insulation is unnecessary between the positive electrode collector electrode plate 30 and the positive electrode normal electrode 3 closest thereto. In addition, since a potential difference will not arise between the negative electrode normal electrode 4 and the negative electrode collector electrode plate 31, an insulation sheet is not arranged between these and the outer packaging 12.

The occurrence status of the potential difference corresponding to the lamination layer of the single laminate bodies 25 within the composite parallel connection body 29s is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the six-pole series of FIG. 48 being an nine-group parallel connection, NWS is 5+1 at the positive electrode tab 10, and NWS is 5+1 also at the negative electrode tab 11. The output electromotive force E is obtained between the positive electrode tab 10 and negative electrode tab 11.

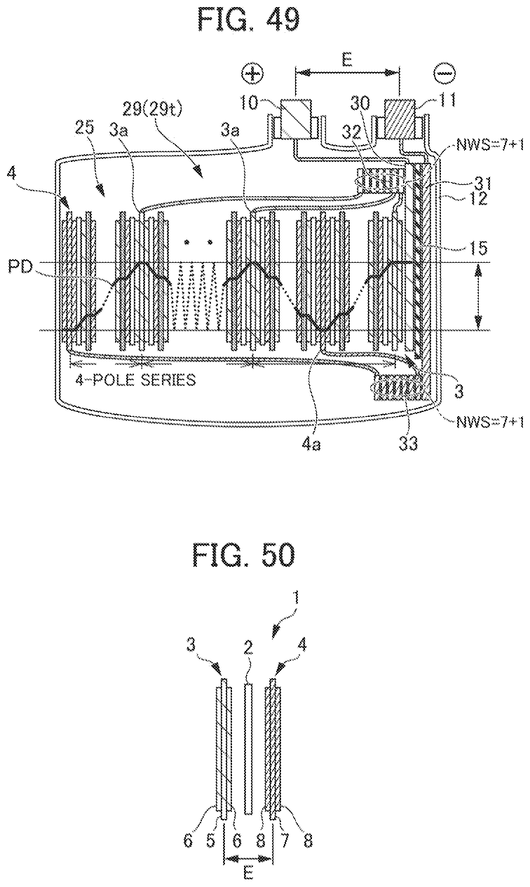

FIG. 49 is a configuration which connects in parallel thirteen of the laminate bodies of four layers made by laminating four single laminate bodies 25 in series, and can be seen as being the composite parallel connection body 29 (29t) made by connecting thirteen groups in parallel of four-pole series. In the case of FIG. 49, the positive electrode collector electrode plate 30 and the negative electrode collector electrode plate 31 are arranged in parallel at one end side among both ends in the lamination direction of the single laminate body 25. In this case, the negative electrode collector electrode plate 31 is arranged closer to the outer side than this one end. The conductors on the positive electrode side for connecting in parallel the laminate body of four layers are brought together at the positive electrode concentration connection part 32 and welded to the positive electrode collector electrode plate 30. In addition, the conductors on the negative electrode side for connecting in parallel the laminate body of four layers are brought together at the negative electrode concentration connection part 33 and welded to the negative electrode collector electrode plate 31. The composite parallel connection body 29t is accommodated in the outer packaging 12 which is a laminate. An intermediate insulation sheet 15 is arranged between the positive electrode collector electrode plate 30 and the negative electrode collector electrode plate 31. In the case of this embodiment, no potential difference arises between the positive electrode collector electrode plate 30 and the positive electrode normal electrode 3 closest thereto. For this reason, insulation is unnecessary between the positive electrode collector electrode plate 30 and the positive electrode normal electrode 3 closest thereto. In addition, since a potential difference will not arise between the negative electrode normal electrode 4 and the negative electrode collector electrode plate 31, an insulation sheet is not arranged between these and the outer packaging 12.

The occurrence status of the potential difference corresponding to the lamination layer of the single laminate bodies 25 within the composite parallel connection body 29t is shown by the bold line as potential difference PD.

The number of conductors brought together at the positive electrode concentration connection part 32 and welded to the positive electrode collector electrode plate 30, i.e. number of wires to the positive electrode tab 10, is indicated as NWS. In addition, the number of conductors brought together at the negative electrode concentration connection part 33 and welded to the negative electrode collector electrode plate 31, i.e. number of wires to the negative electrode tab 11, is indicated as NWS. In the case of the four-pole series of FIG. 49 being an thirteen-group parallel connection, NWS is 7+1 at the positive electrode tab 10, and NWS is 7+1 also at the negative electrode tab 11. The output electromotive force E is obtained between the positive electrode tab 10 and negative electrode tab 11.

According to the secondary battery made using the bipolar electrode of the present embodiment, the following effects are exerted.

The secondary battery made using the bipolar electrode of (1) includes:

a partial power generation element which is configured by a single laminate body, in which the bipolar electrode 17 having the positive electrode mixture slurry 19 coated on one surface and the negative electrode mixture slurry 20 coated on the other surface of one sheet-like collector 18, is laminated on at least one surface side of the solid electrolyte layer 2, or is configured by a multi-layer laminate body in which a plurality of the single laminate bodies is laminated; and the positive electrode normal electrode 3, negative electrode normal electrode 4 of a form laminated directly or indirectly via the solid electrolyte layer 2 on the one surface side and the other surface side of the partial power generation element, and in which poles of the same polarity are formed on both surfaces of one sheet-like collector 18, in which the partial power generation elements configure a serial partial power generation element in which the single laminate bodies which are constituent elements of the multi-layer laminate body are laminated between the positive electrode normal electrode 3 and negative electrode normal electrode 4 with an orientation of polarity configuring a serial connection, and configure a parallel connection body in which the serial partial power generation elements are joined with reversed polarity sandwiching the positive electrode collector electrode 3a (negative electrode collector electrode 4a), between the positive electrode collector electrode 3a (negative electrode collector electrode 4a) and two of the negative electrode collector electrodes 4a (positive electrode collector electrode 3a) corresponding thereto, and the serial partial power generation elements are connected in parallel between the positive electrode collector electrode 3a (negative electrode collector electrode 4a) and two of the negative electrode collector electrodes 4a (positive electrode collector electrode 3a) corresponding thereto. For this reason, a connection conductor for configuring a parallel connection body is not needed at a portion of the positive electrode collector electrode 3a (negative electrode collector electrode 4a), and the number of connection conductors as a whole is reduced.

With the secondary battery made using the bipolar electrode of (2), the normal electrode is either of the positive electrode normal electrode 3 and negative electrode normal electrode 4. For this reason, relative to the positive electrode collector electrode 3a (negative electrode collector electrode 4a) serving as a shared electrode, a bipolar battery (battery made using a bipolar electrode) of serial connection serving as the target of parallel connection is configured between the shared electrode and the positive electrode collector electrode 3a, and between the shared electrode and the negative electrode collector electrode 4a, and simplification in configuration is realized.

The secondary battery made using the bipolar electrode of (3), with one positive electrode normal electrode 3 as the positive electrode collector electrode 3a, configures a parallel connection body 27a, 27b, 27c of the first form in which serial partial power generation elements are joined with reverse polarity sandwiching the positive electrode collector electrode 3a, between the positive electrode collector electrode 3a and two negative electrode normal electrodes 4 corresponding thereto, and in which this serial partial power generation element is connected in parallel between the positive electrode collector electrode 3a and two negative electrode normal electrodes 4. For this reason, the parallel connection body of the first form in which serial connection bodies of the bipolar battery are connected in parallel is simply configured, and it is possible to utilized even as an element of a more complex configuration.

The secondary battery made using the bipolar electrode of (4) configures, with one negative electrode normal electrode 4 as the negative electrode collector electrode 4a, configures a parallel connection body 28 of the second form in which serial partial power generation elements are joined with reverse polarity sandwiching the negative electrode collector electrode 4a, between the negative electrode collector electrode 4a and two positive electrode normal electrodes 3 corresponding thereto, and in which this serial partial power generation element is connected in parallel between the negative electrode collector electrode 4a and two positive electrode normal electrodes 3. For this reason, the parallel connection body of the second form in which serial connection bodies of the bipolar battery are connected in parallel is simply configured, and it is possible to utilized even as an element of a more complex configuration.

With the secondary battery made using the bipolar electrode of (5), a parallel connection body 27a, 27b, 27c of the first form, with one positive electrode normal electrode 3 as the positive electrode collector electrode 3a, in which serial partial power generation elements are joined with reverse polarity sandwiching the positive electrode collector electrode 3a, between the positive electrode collector electrode 3a and two negative electrode normal electrodes 4 corresponding thereto, and in which this serial partial power generation element is connected in parallel between the positive electrode collector electrode 3a and two negative electrode normal electrodes 4, and a parallel connection body 28 of the second form, with one negative electrode normal electrode 4 as the negative electrode collector electrode 4a, in which serial partial power generation elements are joined with reverse polarity sandwiching the negative electrode collector electrode 4a, between the negative electrode collector electrode 4a and two positive electrode normal electrodes 3 corresponding thereto, and in which this serial partial power generation element is connected in parallel between the negative electrode collector electrode 4a and two positive electrode normal electrodes 3, together configure a composite parallel connection body 29a, 29b, . . . 29t by sharing the serial partial power generation element between the positive electrode collector electrode 3a or the negative electrode collector electrode 4a, and one of the negative electrode normal electrode 4 or the positive electrode normal electrode 3. For this reason, a battery of composite parallel type which obtains the required output voltage by a series number (serial pole number) of the serial connection body of single laminate bodies, and obtains the required capacity by the parallel group number of this serial pole number is easily configured.

With the secondary battery made using the bipolar electrode of (6), positive electrode sub-connection conductors 101, 102, 120a, 120b, 120c, 120d; negative electrode sub-connection conductors 111, 112, 130a, 130b, 130c, 130d are respectively provided to correspond to the positive electrode collector electrode 3a and negative electrode collector electrode 4a, and the positive electrode collector electrode plate 30 and negative electrode collector electrode plate 31 for supplying output power to outside are provided collectively to each of these connection conductors of positive polarity and negative polarity. For this reason, connection of conductors for guiding output to outside from the composite parallel connection body of (5) is simplified.

With the secondary battery made using the bipolar electrode of (7), the positive electrode collector electrode plate 3a and the negative electrode collector electrode plate 4a, as well as the partial power generation element have a projected shape to a plane perpendicular to the lamination direction of the partial power generation element which is an approximate rectangular shape, and the positive electrode collector electrode 3a and negative electrode collector electrode 4a have electrodes 30a, 30b, 30c, 30d; 31a, 31b, 31c, 31d, which connect to the positive sub-connection conductors 101, 102, 120a, 120b, 120c, 120d; negative electrode sub-connection conductors 111, 112, 130a, 130b, 130c, 130d which are corresponding, formed at a plurality of locations to be separated in a vicinity of diagonals of the approximate rectangular shape. For this reason, the electrical current flow paths related to the arrangement of conductors in the case of guiding the output to outside from the composite parallel connection body of (6) are differentiated for both positive and negative electrodes, and differentiation of the internal resistance value can be measured.

With the secondary battery made using the bipolar electrode of (8), the composite parallel connection body has the negative electrode normal electrodes located at both of the outermost end sites in the lamination direction thereof. For this reason, the potentials at the both end portions of the laminate close to the outer side are equal, and safety is ensured even without providing an insulating body or the like for reinforcing between the outer packaging.

With the secondary battery made using the bipolar electrode of (9), the composite parallel connection body has the positive electrode normal electrodes located at both of the outermost end sites in the lamination direction thereof. For this reason, the potentials at the both end portions of the laminate close to the outer side are equal, and safety is ensured even without providing an insulating body or the like for reinforcing between the outer packaging.

With the secondary battery made using the bipolar electrode of (10), the positive electrode collector electrode 3a and negative electrode collector electrode 4a are respectively provided with the positive electrode tab 10 and negative electrode tab 11 for supplying output power to outside. For this reason, the configuration of the conductor part for drawing out the output power is simplified.

The secondary battery made using the bipolar electrode of (11), further includes the outer packaging 12 of laminate material enveloping the composite parallel connection body and the connection conductors of positive polarity and negative polarity, in which a part of the positive electrode tab 10 and the negative electrode tab 11 are respectively led to outside from the outer packaging 12. For this reason, handling is easy.

With the secondary battery made using the bipolar electrode of (12), the secondary battery connects in parallel an odd number of serial multi-layer laminate bodies in which a plurality of the single laminate bodies 25 are laminated in the form of serial connection, and arranges in parallel the positive electrode collector electrode plate 30 and negative electrode collector electrode plate 31 at a central part between both ends in the lamination direction of the single laminate body 25, arranges between the positive electrode collector electrode plate 30 and negative electrode collector electrode plate 31 the intermediate insulation sheet 15 which insulates between both collector electrode plates, and does not provide an insulation sheet between both outermost ends in the lamination direction of the single laminate body 25 and the inner surface of the outer packaging 12. With this configuration, the both outermost ends in the lamination direction of the single laminate body 25 are the same potential. For this reason, it is possible to ensure safety, while reducing the number of insulation sheets by assuming a configuration not providing an insulation sheet between both outermost ends in the lamination direction of the single laminate body 25 and the inner surface of the outer packaging.

With the secondary battery made using the bipolar electrode of (13), the secondary battery connects in parallel an odd number of serial multi-layer laminate bodies in which a plurality of the single laminate bodies 25 are laminated in the form of serial connection, and arranges in parallel the positive electrode collector electrode plate 30 and negative electrode collector electrode plate 31 at one end side among both ends in the lamination direction of the single laminate body 25 so that the negative electrode collector electrode plate 31 is closer to the outer side than the one end, arranges between the positive electrode collector electrode plate 30 and negative electrode collector electrode plate 31 the intermediate insulation sheet which insulates between both collector electrode plates, and does not provide an insulation sheet between the other end side among both ends in the lamination direction of the single laminate body 25 and the inner surface of the outer packaging 12, and between the negative electrode collector electrode plate and the inner surface of the outer packaging 12. With this configuration, the negative electrode collector electrode plate 31 and one end side among both ends in the lamination direction of the single laminate body 25 become the same potential. For this reason, it is possible to assume a configuration not providing an insulation sheet between the negative electrode collector electrode plate 31, other end side among both ends in the lamination direction of the single laminate body 25 and the inner surface of the outer packaging 12, and between the negative electrode collector electrode plate 31 and inner surface of the outer packaging 12. For this reason, it is possible to ensure safety, while reducing the number of insulation sheets.

Although embodiments of the present invention have been explained above, the present invention is not to be limited thereto. The configuration of detailed parts may be modified as appropriate within a scope of the gist of the present invention. For example, in the aforementioned example, although a configuration applying a laminate as the outer packaging of the secondary battery was adopted, another material may be applied.

### EXPLANATION OF REFERENCE NUMERALS

1 solid state battery
2 solid electrolyte layer
3 positive electrode normal electrode
3a positive electrode collector electrode
4 negative electrode normal electrode
4a negative electrode collector electrode
5 positive electrode sheet-like collector
5a, 5b, 5c, 5d positive electrode
6 positive electrode mixture
7 negative electrode sheet-like collector
7a, 7b, 7c, 7d negative electrode
8 negative electrode mixture
9 power generation unit
10 positive electrode tab
10a positive electrode terminal
11 negative electrode tab
11a negative electrode terminal
12 outer packaging
13 (other) power generation unit
14 midpoint potential connection part
15 intermediate insulation sheet
16 outer packaging inner surface insulation sheet
17 bipolar electrode
17a bipolar electrode of first form
18 sheet-like collector (current collector foil)
19 positive electrode mixture slurry
20 negative electrode mixture slurry
21 secondary battery (unit battery)
22 partial unit battery of first form
23 partial unit battery of second form
24 partial unit battery of third form
25 single laminate body (partial power generation element)
26 (26a, 26b, 26c, 26d) serial partial power generation element
27 (27a, 27b, 27c) parallel connection body of first form
28 parallel connection body of second form
29 (29a, 29b, 29t) composite parallel connection body
30 positive electrode collector electrode plate
30a, 30b, 30c, 30d electrode
31 negative electrode collector electrode plate
31a, 31b, 31c, 31d electrode
32 positive electrode concentration connection part
33 negative electrode concentration connection part
100 positive electrode main connection conductor
101, 102 positive electrode sub-connection conductor
110 negative electrode main connection conductor
111, 112 negative electrode connection conductor
120a, 120b, 120c, 120d positive electrode sub-connection conductor
130a, 130b, 130c, 130d negative electrode sub-connection conductor

What is claimed is:

1. A secondary battery comprising a bipolar electrode including:
a partial power generation element which is configured by a single laminate body, in which bipolar electrode having a positive electrode of a polarizable electrode formed on one surface and a negative electrode of the polarizable electrode formed on the other surface of one sheet-like collector, is laminated on at least one surface side of a solid electrolyte layer, or is configured by a multi-layer laminate body in which a plurality of the single laminate bodies is laminated; and
a normal electrode of a form laminated directly or indirectly via the solid electrolyte layer on the one surface side and the other surface side of the partial power generation element, and in which poles of the same polarity are formed on both surfaces of one sheet-like collector,
wherein the partial power generation elements configure a serial partial power generation element in which the single laminate bodies which are constituent elements of the multi-layer laminate body are laminated between the normal electrode on the one surface side and the other surface side with an orientation of polarity configuring a serial connection, and configure, with one of the normal electrodes as a shared electrode, a parallel connection body in which the serial partial power generation elements are joined with reversed polarity sandwiching the shared electrode, between the shared electrode and two of the normal electrodes corresponding thereto, and the serial partial power generation elements are connected in parallel between the shared electrode and two of the normal electrodes.

2. The secondary battery comprising the bipolar electrode according to claim 1,
wherein the normal electrode is either a positive electrode normal electrode of a form laminated on one surface side of the partial power generation element and having a pole of positive polarity formed on both surfaces of one sheet-like collector, or a negative electrode normal electrode laminated on the other surface side of the partial power generation element and having a pole of negative polarity formed on both surfaces of the one sheet-like collector.

3. The secondary battery comprising the bipolar electrode according to claim 2,
wherein the secondary battery configures a parallel connection body of a first form in which the serial partial power generation element is joined, with one of the positive electrode normal electrodes as a positive electrode collector electrode, between the positive electrode collector electrode and two of the negative electrode normal electrodes corresponding thereto, to sandwich the positive electrode collector electrode with reversed polarity, and the serial partial power generation element is connected in parallel between the positive electrode collector electrode and two of the negative electrode normal electrodes.

4. The secondary battery comprising the bipolar electrode according to claim 2,
wherein the secondary battery configures a parallel connection body of a second form in which the serial partial power generation element is joined, with one of the negative electrode normal electrodes as a negative electrode collector electrode, between the negative electrode collector electrode and two of the positive electrode normal electrodes corresponding thereto, to sandwich the negative electrode collector electrode with reversed polarity, and the serial partial power generation element is connected in parallel between the negative electrode collector electrode and two of the positive electrode normal electrodes.

5. The secondary battery comprising the bipolar electrode according to claim 2,
wherein a parallel connection body of a first form in which the serial partial power generation element is joined, with one of the positive electrode normal electrodes as a positive electrode collector electrode, between the positive electrode collector electrode and two of the negative electrode normal electrodes corresponding thereto, to sandwich the positive electrode collector electrode with reversed polarity, and the serial partial power generation element is connected in parallel between the positive electrode collector electrode and two of the negative electrode normal electrode, and
a parallel connection body of a second form in which the serial partial power generation element is joined, with one of the negative electrode normal electrodes as a negative electrode collector electrode, between the negative electrode collector electrode and two of the positive electrode normal electrodes corresponding thereto, to sandwich the negative electrode collector electrode with reversed polarity, and the serial partial power generation element is connected in parallel between the negative electrode collector electrode and two of the positive electrode normal electrode, configure a composite parallel connection body by sharing the serial partial power generation element between the positive electrode collector electrode or the negative electrode collector electrode, and one of the negative electrode normal electrode or the positive electrode normal electrode.

6. The secondary battery comprising the bipolar electrode according to claim 5,
wherein the composite parallel connection body provides a connection conductor corresponding to each of the positive collector electrode and the negative collector electrode, and provides a positive electrode collector electrode plate and a negative electrode collector electrode plate for supplying output power to outside collectively to each of the connection conductors of positive polarity and negative polarity.

7. The secondary battery comprising the bipolar electrode according to claim 6,
wherein the positive electrode collector electrode plate and the negative electrode collector electrode plate, as well as the partial power generation element have a projected shape to a plane perpendicular to the lamination direction of the partial power generation element which is an approximate rectangular shape, and
wherein the positive electrode collector electrode plate and the negative electrode collector electrode plate have conductor connection parts, which connect to the connection conductors of positive polarity and negative polarity which are corresponding, formed at a plurality of locations to be separated in a vicinity of diagonals of the approximate rectangular shape.

8. The secondary battery comprising the bipolar electrode according to claim 5,
wherein the negative electrode normal electrode is located at both outermost end portions in the lamination direction of the composite parallel connection body.

9. The secondary battery comprising the bipolar electrode according to claim 5,
wherein the positive electrode normal electrode is located at both outermost end sites in the lamination direction of the composite parallel connection body.

10. The secondary battery comprising the bipolar electrode according to claim 6,
wherein a positive electrode tab and a negative electrode tab for supplying output electric power to outside are respectively provided in the positive electrode collector electrode plate and the negative electrode collector electrode plate.

11. The secondary battery comprising the bipolar electrode according to claim 10,
further comprising an outer packaging of laminate material enveloping the composite parallel connection body and the connection conductors of positive polarity and negative polarity, wherein a part of the positive electrode tab and the negative electrode tab are respectively led to outside from the outer packaging.

12. The secondary battery comprising the bipolar electrode according to claim 11,
wherein the secondary battery connects in parallel an odd number of a serial-multi-layer laminate body in which a plurality of single laminate bodies are laminated in a form of serial connection; disposes in parallel the positive electrode collector electrode plate and the negative electrode collector electrode plate at a central part between both ends in the lamination direction of the single laminate bodies; arranges between the positive electrode collector electrode plate and the negative electrode collector electrode plate an intermediate insulation sheet insulating between both of the collector electrode plates; and does not provide an insulation sheet between both outermost ends in the lamination direction of the single laminate bodies and an inner surface of the outer packaging.

13. The secondary battery comprising the bipolar electrode according to claim 11,
wherein the secondary battery connects in parallel an odd number of a serial-multi-layer laminate body in which a plurality of single laminate bodies are laminated in a form of serial connection; arranges in parallel the positive electrode collector electrode plate and the negative electrode collector electrode plate at one end side among both ends in the lamination direction of the single laminate bodies, so that the negative electrode collector electrode plate is closed to an outer side than the one end; arranges between the positive electrode collector electrode plate and the negative electrode collector electrode plate an intermediate insulation sheet insulating between both of the collector electrode plates; and does not provide an insulation sheet between the other end side among both ends in the lamination direction of the single laminate bodies and the inner surface of the outer packaging, and between the negative electrode collector electrode plate and the inner surface of the outer packaging.

14. The secondary battery comprising the bipolar electrode according to claim 7,
wherein the positive electrode collector electrode plate and the negative electrode collector electrode plate are provided with a positive electrode tab and a negative electrode tab for supplying output power to outside.

15. The secondary battery comprising the bipolar electrode according to claim 14,
further comprising an outer packaging of laminate material enveloping the composite parallel connection body and the connection conductors of positive polarity and negative polarity, wherein a part of the positive electrode tab and the negative electrode tab are respectively led to outside from the outer packaging.

16. The secondary battery comprising the bipolar electrode according to claim 15,
wherein the secondary battery connects in parallel an odd number of a serial-multi-layer laminate body in which a plurality of single laminate bodies are laminated in a form of serial connection; disposes in parallel the positive electrode collector electrode plate and the negative electrode collector electrode plate at a central part between both ends in the lamination direction of the single laminate bodies; arranges between the positive electrode collector electrode plate and the negative electrode collector electrode plate an intermediate insulation sheet insulating between both of the collector electrode plates; and does not provide an insulation sheet between both outermost ends in the lamination direction of the single laminate bodies and an inner surface of the outer packaging.

17. The secondary battery comprising the bipolar electrode according to claim 15,
wherein the secondary battery connects in parallel an odd number of a serial-multi-layer laminate body in which a plurality of single laminate bodies are laminated in a form of serial connection; arranges in parallel the positive electrode collector electrode plate and the negative electrode collector electrode plate at one end side among both ends in the lamination direction of the single laminate bodies, so that the negative electrode collector electrode plate is closed to an outer side than the one end; arranges between the positive electrode collector electrode plate and the negative electrode collector electrode plate an intermediate insulation sheet insulating between both of the collector electrode plates; and does not provide an insulation sheet between the other end side among both ends in the lamination direction of the single laminate bodies and the inner surface of the outer packaging, and between the negative electrode collector electrode plate and the inner surface of the outer packaging.
